(19) United States
(12) Patent Application Publication
(10) Pub. No.: US 2026/0343309 A1
(43) Pub. Date: Oct. 29, 2026

(54) COMMUNICATION METHOD AND APPARATUS

(71) Applicant: HUAWEI TECHNOLOGIES CO., LTD., Shenzhen (CN)

(72) Inventors: Yao Xiao, Shenzhen (CN); Lu Yang, Shenzhen (CN); Wenhui Wang, Shanghai (CN); Yousi Lin, Shenzhen (CN); Mengyao Ma, Shenzhen (CN); Li Sun, Shenzhen (CN)

(73) Assignee: HUAWEI TECHNOLOGIES CO., LTD., Shenzhen (CN)

(21) Appl. No.: 19/631,356

(22) Filed: Mar. 27, 2026

Related U.S. Application Data
(63) Continuation of application No. PCT/CN2023/123043, filed on Sep. 29, 2023.

(51) Int. Cl. H04W 28/02

(52) U.S. Cl. CPC H04W 28/0236

(57) ABSTRACT

A first communication apparatus obtains a third quantity of streams that is determined based on a first quantity of streams and/or a second quantity of streams, and sends information to a second communication apparatus based on first channel information and the third quantity of streams. The first quantity of streams is determined based on the first channel information from the second communication apparatus to the first communication apparatus. The second quantity of streams is determined based on second channel information from the first communication apparatus to the second communication apparatus. The third quantity of streams is less than or equal to a maximum quantity of streams corresponding to the first channel information.

### CROSS-REFERENCE TO RELATED APPLICATION

This is a continuation of International Patent Application No. PCT/CN2023/123043 filed on Sep. 29, 2023, which is hereby incorporated by reference in its entirety.

### TECHNICAL FIELD

This disclosure relates to the field of communication technologies, and in particular, to a communication method and apparatus.

### BACKGROUND

In some scenarios, channels between two devices exhibit reciprocity. For example, in a time-division duplex (TDD) system of a massive multiple-input multiple-output (MIMO) system, signal transmission of an uplink channel and signal transmission of a downlink channel are performed at a same frequency. To avoid interference between adjacent links, a time interval is usually set between the signal transmission of the uplink channel and the signal transmission of the downlink channel. When the time interval is short enough, a fading difference between the uplink channel and the downlink channel may be considered small. In this case, there is reciprocity between the uplink channel and the downlink channel.

Currently, based on the reciprocity between the uplink channel and the downlink channel in the TDD system, communication of the downlink channel can be configured based on channel information of the uplink channel. If a channel change degree within the time interval is large, or communication components at a transmit end and a receive end are configured inconsistently, there is a large fading difference between the uplink channel and the downlink channel. Consequently, the channel information of the uplink channel is inconsistent with that of the downlink channel, resulting in impact on accuracy of configuring the communication of the downlink channel.

### SUMMARY

This disclosure provides a communication method and apparatus, which can improve consistency of channel information extracted by both communication parties.

According to a first aspect, this disclosure provides a communication method, including: a first communication apparatus obtains a third quantity of streams. The third quantity of streams is determined based on a first quantity of streams and/or a second quantity of streams. The first quantity of streams is determined based on first channel information from a second communication apparatus to the first communication apparatus. The second quantity of streams is determined based on second channel information from the first communication apparatus to the second communication apparatus. The third quantity of streams is less than or equal to a maximum quantity of streams corresponding to the first channel information. Then, the first communication apparatus sends information to the second communication apparatus based on the first channel information and the third quantity of streams.

The third quantity of streams used to preprocess the channel information is designed. The first communication apparatus and the second communication apparatus use the same third quantity of streams to preprocess the channel information, so that consistency of channel information extracted by both communication parties can be improved. For example, when the method is applied to a TDD downlink precoding scenario, adaptability of a weight calculated by a network device based on an uplink channel to a downlink channel can be improved by leveraging the consistency of the extracted channel information, to improve accuracy of configuring communication of the downlink channel.

In a possible design, the first quantity of streams satisfies a first condition. The first condition is determined based on a signal-to-noise ratio corresponding to the first channel information and a singular value of at least one stream of the first channel information. For example, the first condition includes: a ratio of a singular value of a primary stream of the first channel information to a singular value of an i^{th} stream in singular values of L1 streams of the first channel information is less than or equal to a first threshold. The first threshold is determined based on the signal-to-noise ratio corresponding to the first channel information. i is an integer from 1 to L1. A value of the first quantity of streams is L1. In this design, first L1 streams with high information energy in all streams of the first communication apparatus can be determined. When the third quantity of streams is determined based on the first quantity L1 of streams, it can be ensured that L (the third quantity of streams) streams used to preprocess the channel information have high information energy, to facilitate the consistency and effectiveness of the extracted channel information.

In a possible design, the first communication apparatus may determine first communication configuration information based on singular values of L streams of the first channel information and a weight coefficient corresponding to each piece of singular value information in the singular values of the L streams; and send the information to the second communication apparatus based on the first communication configuration information. A value of L is the third quantity of streams. The first communication configuration information includes one or more of precoding information, a channel coding parameter, a modulation parameter, or a first key used for encrypted communication. In the foregoing design, adaptability of the first communication configuration information to a channel from the first communication apparatus to the second communication apparatus can be improved by leveraging the consistency of the extracted channel information, to ensure communication configuration accuracy and improve communication performance.

In a possible design, the first communication apparatus may determine a first parameter based on the singular values of the L streams of the first channel information and the weight coefficient corresponding to each piece of singular value information in the singular values of the L streams; and determine the first communication configuration information based on the first parameter.

In a possible design, the first parameter [symbol] (H_{ba}) satisfies the following relation:

$$ℒ ( {H}_{ba} ) = {\sum }_{l = 1}^{L} {w}_{l} * {σ}_{l} ( {H}_{ba} ) .$$

wₗ indicates a weight coefficient corresponding to an l^{th} piece of singular value information in the singular values of the L streams. H_{ba} indicates the first channel information. σₗ(H_{ba}) indicates a singular value of an l^{th} stream in the singular values of the L streams of the first channel information. l is an integer from 1 to L.

In this design, a difference between the first parameter [symbol] (H_{ba}) and a second parameter [symbol] (H_{ab}) determined by the second communication apparatus can be reduced, so that a difference between communication configuration information determined by both communication parties based on the parameters is small, to help improve the communication performance. For example, the first parameter [symbol] (H_{ba}) and the second parameter [symbol] (H_{ab}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) .$$

The second parameter [symbol] (H_{ab}) is determined based on singular values of L streams of the second channel information and a weight coefficient corresponding to each piece of singular value information in the singular values of the L streams. σ₁(E) is determined based on channel noise between the first communication apparatus and the second communication apparatus.

In a possible design, before obtaining the third quantity of streams, the first communication apparatus may further establish a secure connection to the second communication apparatus. In this design, information security of both communication parties can be improved.

Several designs in which the first communication apparatus obtains the third quantity of streams are described below by using examples.

In a first possible design, the first communication apparatus may receive the third quantity of streams that is indicated by the second communication apparatus. The third quantity of streams is less than or equal to the second quantity of streams.

In a second possible design, the first communication apparatus may indicate the first quantity of streams to the second communication apparatus; and receive first indication information from the second communication apparatus. The first indication information indicates that the first quantity of streams is the same as the second quantity of streams, and the third quantity of streams is the first quantity of streams; or the first indication information indicates the third quantity of streams, and the third quantity of streams is less than or equal to the smaller one of the first quantity of streams and the second quantity of streams.

In a third possible design, the first communication apparatus may receive the second quantity of streams that is indicated by the second communication apparatus; and determine the third quantity of streams based on the first quantity of streams and the second quantity of streams. If the first quantity of streams is the same as the second quantity of streams, the third quantity of streams is the first quantity of streams; or if the first quantity of streams is different from the second quantity of streams, the third quantity of streams is less than or equal to the smaller one of the first quantity of streams and the second quantity of streams. Optionally, the first communication apparatus may further send second indication information to the second communication apparatus. The second indication information indicates that the first quantity of streams is the same as the second quantity of streams, or the second indication information indicates the third quantity of streams.

According to a second aspect, this disclosure provides a communication method, including: a second communication apparatus obtains a third quantity of streams. The third quantity of streams is determined based on a first quantity of streams and/or a second quantity of streams. The first quantity of streams is determined based on first channel information from the second communication apparatus to a first communication apparatus. The second quantity of streams is determined based on second channel information from the first communication apparatus to the second communication apparatus. The third quantity of streams is less than or equal to a maximum quantity of streams corresponding to the second channel information. Then, the second communication apparatus sends information to the first communication apparatus based on the second channel information and the third quantity of streams.

The third quantity of streams used to preprocess the channel information is designed. The first communication apparatus and the second communication apparatus use the same third quantity of streams to preprocess the channel information, so that consistency of channel information extracted by both communication parties can be improved. When the method is applied to a TDD downlink precoding scenario, adaptability of a weight calculated by a network device based on an uplink channel to a downlink channel can be improved by leveraging the consistency of the extracted channel information, to improve accuracy of configuring communication of the downlink channel.

In a possible design, the second quantity of streams satisfies a second condition. The second condition is determined based on a signal-to-noise ratio corresponding to the second channel information and a singular value of at least one stream of the second channel information. For example, the second condition includes: a ratio of a singular value of a primary stream of the second channel information to a singular value of a j^{th} stream in singular values of L2 streams of the second channel information is less than or equal to a second threshold. The second threshold is determined based on the signal-to-noise ratio corresponding to the second channel information. j is an integer from 1 to L2. A value of the second quantity of streams is L2. In this design, first L2 streams with high information energy in all streams of the second communication apparatus can be determined. When the third quantity of streams is determined based on the second quantity L2 of streams, it can be ensured that L (the third quantity of streams) streams used to preprocess the channel information have high information energy, to facilitate the consistency and effectiveness of the extracted channel information.

In a possible design, the second communication apparatus may determine second communication configuration information based on singular values of L streams of the second channel information and a weight coefficient corresponding to each piece of singular value information in the singular values of the L streams; and send the information to the first communication apparatus based on the second communication configuration information. A value of L is the third quantity of streams. The second communication configuration information includes one or more of precoding information, a channel coding parameter, a modulation parameter, or a second key used for encrypted communication. In the foregoing design, adaptability of the second communication configuration information to a channel from the second communication apparatus to the first communication apparatus can be improved by leveraging the consistency of the extracted channel information, to ensure communication configuration accuracy and improve communication performance.

In a possible design, the second communication apparatus may determine a second parameter based on the singular values of the L streams of the second channel information and the weight coefficient corresponding to each piece of singular value information in the singular values of the L streams; and determine the second communication configuration information based on the second parameter.

In a possible design, the second parameter [symbol] (H_{ab}) satisfies the following relation:

$$ℒ ( {H}_{ba} ) = {\sum }_{l = 1}^{L} {w}_{l} * {σ}_{l} ( {H}_{ab} ) .$$

wₗ indicates a weight coefficient corresponding to an l^{th} piece of singular value information in the singular values of the L streams. H_{ab} indicates the second channel information. σₗ(H_{ba}) indicates a singular value of an l^{th} stream in the singular values of the L streams of the second channel information. l is an integer from 1 to L.

In this design, a difference between a first parameter [symbol] (H_{ba}) determined by the first communication apparatus and the second parameter [symbol] (H_{ab}) determined by the second communication apparatus can be reduced, so that a difference between communication configuration information determined by both communication parties based on the parameters is small, to help improve the communication performance. The second parameter [symbol] (H_{ab}) and the first parameter [symbol] (H_{ba}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) .$$

The first parameter [symbol] (H_{ba}) is determined based on singular values of L streams of the first channel information and a weight coefficient corresponding to each piece of singular value information in the singular values of the L streams. σ₁(E) is determined based on channel noise between the first communication apparatus and the second communication apparatus.

In a possible design, before obtaining the third quantity of streams, the second communication apparatus may further establish a secure connection to the first communication apparatus. In this design, information security of both communication parties can be improved.

Several designs in which the second communication apparatus obtains the third quantity of streams are described below by using examples.

In a first possible design, the second communication apparatus may receive the third quantity of streams that is indicated by the first communication apparatus. The third quantity of streams is less than or equal to the first quantity of streams.

In a second possible design, the second communication apparatus may indicate the second quantity of streams to the first communication apparatus; and receive second indication information from the first communication apparatus. The second indication information indicates that the first quantity of streams is the same as the second quantity of streams, and the third quantity of streams is the second quantity of streams; or the second indication information indicates the third quantity of streams, and the third quantity of streams is less than or equal to the smaller one of the first quantity of streams and the second quantity of streams.

In a third possible design, the second communication apparatus may receive the first quantity of streams that is indicated by the first communication apparatus; and determine the third quantity of streams based on the first quantity of streams and the second quantity of streams. If the first quantity of streams is the same as the second quantity of streams, the third quantity of streams is the second quantity of streams; or if the first quantity of streams is different from the second quantity of streams, the third quantity of streams is less than or equal to the smaller one of the first quantity of streams and the second quantity of streams. Optionally, the second communication apparatus may further send first indication information to the first communication apparatus. The first indication information indicates that the first quantity of streams is the same as the second quantity of streams, or the first indication information indicates the third quantity of streams.

According to a third aspect, this disclosure provides a communication apparatus. The apparatus may be configured to perform the method according to the first aspect. The apparatus may be a first communication apparatus, or the apparatus may include a component (for example, a chip, a chip system, or a circuit) in the first communication apparatus, or may be an apparatus that can be used together with the first communication apparatus.

In a possible implementation, the communication apparatus may include a one-to-one corresponding module or unit for performing the method/operation/step/action described in the first aspect. The module or unit may be implemented by a hardware circuit, software, or a combination of a hardware circuit and software. In a possible implementation, the apparatus may include a processing unit (which may also be referred to as a processing module) and a communication unit (which may also be referred to as a communication module). The communication unit may be configured to perform a receiving and/or sending function. The processing unit may be configured to perform the method according to the first aspect or any possible implementation of the first aspect.

For example, the communication apparatus includes a communication module and a processing module. For functions of the modules, refer to the following description for understanding:

The processing module is configured to obtain a third quantity of streams. The third quantity of streams is determined based on a first quantity of streams and/or a second quantity of streams. The first quantity of streams is determined based on first channel information from a second communication apparatus to the first communication apparatus. The second quantity of streams is determined based on second channel information from the first communication apparatus to the second communication apparatus. The third quantity of streams is less than or equal to a maximum quantity of streams corresponding to the first channel information.

The processing module is further configured to send information to the second communication apparatus through the communication module based on the first channel information and the third quantity of streams.

In a possible design, the first quantity of streams satisfies a first condition. The first condition is determined based on a signal-to-noise ratio corresponding to the first channel information and a singular value of at least one stream of the first channel information. Optionally, the first condition includes: a ratio of a singular value of a primary stream of the first channel information to a singular value of an i^{th} stream in singular values of L1 streams of the first channel information is less than or equal to a first threshold. The first threshold is determined based on the signal-to-noise ratio corresponding to the first channel information. i is an integer from 1 to L1. A value of the first quantity of streams is L1.

In a possible design, the processing module is configured to: determine first communication configuration information based on singular values of L streams of the first channel information and a weight coefficient corresponding to each piece of singular value information in the singular values of the L streams; and send the information to the second communication apparatus through the communication module based on the first communication configuration information. A value of L is the third quantity of streams. The first communication configuration information includes one or more of precoding information, a channel coding parameter, a modulation parameter, or a first key used for encrypted communication.

In a possible design, the processing module is configured to: determine a first parameter based on the singular values of the L streams of the first channel information and the weight coefficient corresponding to each piece of singular value information in the singular values of the L streams; and determine the first communication configuration information based on the first parameter.

In a possible design, the first parameter [symbol] (H_{ba}) satisfies the following relation:

$$ℒ ( {H}_{ba} ) = {\sum }_{l = 1}^{L} {w}_{l} * {σ}_{l} ( {H}_{ba} ) .$$

wₗ indicates a weight coefficient corresponding to an l^{th} piece of singular value information in the singular values of the L streams. H_{ba} indicates the first channel information. σₗ(H_{ba}) indicates a singular value of an l^{th} stream in the singular values of the L streams of the first channel information. l is an integer from 1 to L.

In a possible design, the first parameter [symbol] (H_{ba}) and a second parameter [symbol] (H_{ab}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) .$$

The second parameter [symbol] (H_{ab}) is determined based on singular values of L streams of the second channel information and a weight coefficient corresponding to each piece of singular value information in the singular values of the L streams. σ₁(E) is determined based on channel noise between the first communication apparatus and the second communication apparatus.

In a possible design, the processing module is further configured to: before obtaining the third quantity of streams, establish a secure connection to the second communication apparatus through the communication module.

In a possible design, the processing module is further configured to receive, through the communication module, the third quantity of streams that is indicated by the second communication apparatus. The third quantity of streams is less than or equal to the second quantity of streams.

In a possible design, the processing module is further configured to: indicate the first quantity of streams to the second communication apparatus; and receive first indication information from the second communication apparatus through the communication module. The first indication information indicates that the first quantity of streams is the same as the second quantity of streams, and the third quantity of streams is the first quantity of streams; or the first indication information indicates the third quantity of streams, and the third quantity of streams is less than or equal to the smaller one of the first quantity of streams and the second quantity of streams.

In a possible design, the processing module is further configured to: receive, through the communication module, the second quantity of streams that is indicated by the second communication apparatus; and determine the third quantity of streams based on the first quantity of streams and the second quantity of streams. If the first quantity of streams is the same as the second quantity of streams, the third quantity of streams is the first quantity of streams; or if the first quantity of streams is different from the second quantity of streams, the third quantity of streams is less than or equal to the smaller one of the first quantity of streams and the second quantity of streams. Optionally, the processing module is further configured to send second indication information to the second communication apparatus through the communication module. The second indication information indicates that the first quantity of streams is the same as the second quantity of streams, or the second indication information indicates the third quantity of streams.

According to a fourth aspect, the apparatus may be configured to perform the method according to the second aspect. The apparatus may be a second communication apparatus, or the apparatus may include a component (for example, a chip, a chip system, or a circuit) in the second communication apparatus, or may be an apparatus that can be used together with the second communication apparatus.

In a possible implementation, the communication apparatus may include a one-to-one corresponding module or unit for performing the method/operation/step/action described in the second aspect. The module or unit may be implemented by a hardware circuit, software, or a combination of a hardware circuit and software. In a possible implementation, the apparatus may include a processing unit (which may also be referred to as a processing module) and a communication unit (which may also be referred to as a communication module). The communication unit may be configured to perform a receiving and/or sending function. The processing unit may be configured to perform the method according to the second aspect or any possible implementation of the second aspect.

For example, the communication apparatus includes a communication module and a processing module. For functions of the modules, refer to the following description for understanding:

The processing module is configured to obtain a third quantity of streams. The third quantity of streams is determined based on a first quantity of streams and/or a second quantity of streams. The first quantity of streams is determined based on first channel information from the second communication apparatus to a first communication apparatus. The second quantity of streams is determined based on second channel information from the first communication apparatus to the second communication apparatus. The third quantity of streams is less than or equal to a maximum quantity of streams corresponding to the second channel information.

The processing module is further configured to send information to the first communication apparatus through the communication module based on the second channel information and the third quantity of streams.

In a possible design, the second quantity of streams satisfies a second condition. The second condition is determined based on a signal-to-noise ratio corresponding to the second channel information and a singular value of at least one stream of the second channel information. Optionally, the second condition includes: a ratio of a singular value of a primary stream of the second channel information to a singular value of a j^{th} stream in singular values of L2 streams of the second channel information is less than or equal to a second threshold. The second threshold is determined based on the signal-to-noise ratio corresponding to the second channel information. j is an integer from I to L2. A value of the second quantity of streams is L2.

In a possible design, the processing module is configured to: determine second communication configuration information based on singular values of L streams of the second channel information and a weight coefficient corresponding to each piece of singular value information in the singular values of the L streams; and send the information to the first communication apparatus through the communication module based on the second communication configuration information. A value of L is the third quantity of streams. The second communication configuration information includes one or more of precoding information, a channel coding parameter, a modulation parameter, or a second key used for encrypted communication.

In a possible design, the processing module is configured to determine a second parameter based on the singular values of the L streams of the second channel information and the weight coefficient corresponding to each piece of singular value information in the singular values of the L streams; and determine the second communication configuration information based on the second parameter.

In a possible design, the second parameter [symbol] (H_{ab}) satisfies the following relation:

$$ℒ ( {H}_{ba} ) = {\sum }_{l = 1}^{L} {w}_{l} * {σ}_{l} ( {H}_{ab} ) .$$

wₗ indicates a weight coefficient corresponding to an l^{th} piece of singular value information in the singular values of the L streams. H_{ab} indicates the second channel information. σₗ(H_{ba}) indicates a singular value of an l^{th} stream in the singular values of the L streams of the second channel information. l is an integer from 1 to L.

In a possible design, the second parameter [symbol] (H_{ab}) and a first parameter [symbol] (H_{ba}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) .$$

The first parameter [symbol] (H_{ba}) is determined based on singular values of L streams of the first channel information and a weight coefficient corresponding to each piece of singular value information in the singular values of the L streams. σ₁(E) is determined based on channel noise between the first communication apparatus and the second communication apparatus.

In a possible design, the processing module is further configured to: before obtaining the third quantity of streams, establish a secure connection to the first communication apparatus.

In a possible design, the processing module is further configured to receive the third quantity of streams that is indicated by the first communication apparatus. The third quantity of streams is less than or equal to the first quantity of streams.

In a possible design, the processing module is further configured to: indicate the second quantity of streams to the first communication apparatus; and receive second indication information from the first communication apparatus through the communication module. The second indication information indicates that the first quantity of streams is the same as the second quantity of streams, and the third quantity of streams is the second quantity of streams; or the second indication information indicates the third quantity of streams, and the third quantity of streams is less than or equal to the smaller one of the first quantity of streams and the second quantity of streams.

In a possible design, the processing module is further configured to: receive the first quantity of streams that is indicated by the first communication apparatus; and determine the third quantity of streams based on the first quantity of streams and the second quantity of streams. If the first quantity of streams is the same as the second quantity of streams, the third quantity of streams is the second quantity of streams; or if the first quantity of streams is different from the second quantity of streams, the third quantity of streams is less than or equal to the smaller one of the first quantity of streams and the second quantity of streams. Optionally, the processing module is further configured to send first indication information to the first communication apparatus through the communication module. The first indication information indicates that the first quantity of streams is the same as the second quantity of streams, or the first indication information indicates the third quantity of streams.

According to a fifth aspect, this disclosure provides a communication apparatus, including at least one processor. The processor is coupled to a memory. The memory is configured to store a computer program or instructions. When the apparatus runs, the at least one processor executes the computer program or the instructions, to enable the communication apparatus to perform the method according to the first aspect or the embodiments of the first aspect or the method according to the second aspect or the embodiments of the second aspect.

In a possible design, the communication apparatus further includes the memory. Optionally, the memory is integrated with the processor.

In a possible design, the memory is independent of the communication apparatus.

In a possible design, the communication apparatus further includes a transceiver, configured to communicate with another apparatus.

According to a sixth aspect, this disclosure provides another communication apparatus, including a logic circuit and an input/output interface. The input/output interface may be understood as an interface circuit. The logic circuit performs the method according to the first aspect or the embodiments of the first aspect or the method according to the second aspect or the embodiments of the second aspect.

According to a seventh aspect, this disclosure further provides a computer-readable storage medium. The computer-readable storage medium stores computer-readable instructions. When the computer-readable instructions are run on a computer, the computer is enabled to perform the method according to any one of the first aspect or the possible designs of the first aspect or the method according to any one of the second aspect or the possible designs of the second aspect.

According to an eighth aspect, this disclosure provides a computer program product including instructions. When the computer program product is run on a computer, the computer is enabled to perform the method according to the first aspect or the embodiments of the first aspect or the method according to the second aspect or the embodiments of the second aspect.

According to a ninth aspect, this disclosure provides a chip system. The chip system includes a processor, may optionally further include a memory, and is configured to implement the method according to any one of the first aspect or the possible designs of the first aspect or the method according to any one of the second aspect or the possible designs of the second aspect. The chip system may include a chip, or may include a chip and another discrete device.

According to a tenth aspect, this disclosure provides a communication system. The system includes a first communication apparatus and a second communication apparatus. The communication system is configured to perform the method according to any one of the first aspect or the possible designs of the first aspect or the method according to any one of the second aspect or the possible designs of the second aspect.

For technical effects that can be achieved in the third aspect to the tenth aspect, refer to descriptions of technical effects that can be achieved by corresponding possible design solutions in the first aspect or the second aspect. Details are not described herein again in this disclosure.

### BRIEF DESCRIPTION OF DRAWINGS

FIG. 1 is a diagram of a structure of a communication system;

FIG. 2 to FIG. 4 are diagrams of interaction between a network device and a terminal device;

FIG. 5 to FIG. 9 are schematic flowcharts of several communication methods according to embodiments of this disclosure;

FIG. 10 is a diagram of a communication scenario;

FIG. 11 is a schematic flowchart of a communication method according to an embodiment of this disclosure;

FIG. 12 is a diagram of a probability distribution corresponding to key generation;

FIG. 13 to FIG. 15 are diagrams of effect of an encryption solution according to an embodiment of this disclosure;

FIG. 16 is a diagram of a structure of a communication apparatus according to an embodiment of this disclosure; and

FIG. 17 is a diagram of a structure of another communication apparatus according to an embodiment of this disclosure.

### DESCRIPTION OF EMBODIMENTS

To make objectives, technical solutions, and advantages of embodiments of this disclosure clearer, the following further describes embodiments of this disclosure in detail with reference to the accompanying drawings.

At least one (item) in embodiments of this disclosure indicates one or more (items). A plurality of pieces (items) means two or more pieces (items). The term “and/or” describes an association relationship between associated objects and represents that three relationships may exist. For example, A and/or B may represent the following three cases: only A exists, both A and B exist, and only B exists. The character “/” generally indicates an “or” relationship between associated objects. In addition, it should be understood that although terms such as first and second may be used in embodiments of this disclosure to describe objects, these objects should not be limited by these terms. The terms are merely used for distinguishing the objects from each other.

The terms “include”, “have”, and any variants thereof in the following descriptions of embodiments of this disclosure are intended to cover a non-exclusive inclusion. For example, a process, a method, a system, a product, or a device that includes a series of steps or units is not limited to the listed steps or units, but optionally further includes other unlisted steps or units, or optionally further includes other inherent steps or units of the process, the method, the product, or the device. It should be noted that in embodiments of this disclosure, the term “example”, “for example”, or the like is used to represent giving an example, an illustration, or a description. Any method or design solution described as an “example” or “for example” in embodiments of this disclosure should not be explained as being more preferred or having more advantages than another method or design solution. Rather, use of the term “example”, “for example”, or the like is intended to present a relative concept in a specific manner.

The technical solutions provided in this disclosure may be applied to various communication systems, for example, a 5th-generation (5G) or New Radio (NR) system, a Long-Term Evolution (LTE) system, an LTE frequency-division duplex (FDD) system, an LTE TDD system, a satellite communication system, a communication system evolved after 5G such as a 6th-generation (6G) mobile communication system, or a converged system of a plurality of systems. The technical solutions provided in this disclosure may also be applied to device-to-device (D2D) communication, vehicle-to-everything (V2X) communication, machine-to-machine (M2M) communication, machine-type communication (MTC), an Internet of things (IoT) communication system, or another communication system.

A network element in the communication system may send a signal to another network element or receive a signal from another network element. The signal may include information, signaling, data, or the like. The network element may also be replaced with an entity, a network entity, a device, a communication device, a communication module, a node, a communication node, or the like. For example, the communication system may include at least one terminal device and at least one network device. The network device may send a downlink signal to the terminal device, and/or the terminal device may send an uplink signal to the network device. In addition, it may be understood that if the communication system includes a plurality of terminal devices, the plurality of terminal devices may also send a signal to each other. In other words, both a network element that sends a signal and a network element that receives the signal may be terminal devices.

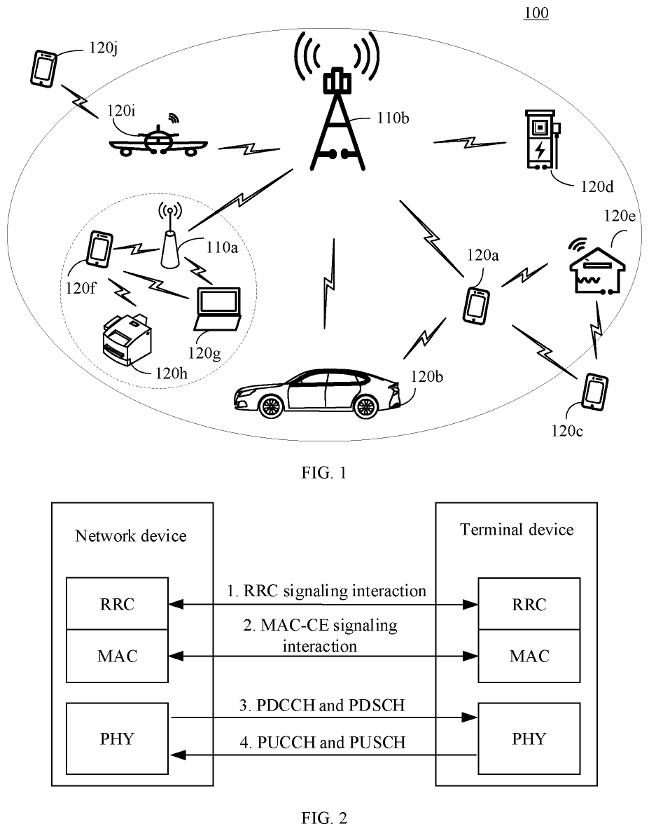

FIG. 1 shows a communication system 100. The wireless communication system includes a radio access network 100. The radio access network 100 may be a next generation (for example, 6G or later) radio access network, or another (for example, 5G or 4th-generation (4G)) radio access network. One or more terminal devices (120a to 120j, collectively referred to as 120) may be interconnected or connected to one or more network devices (110a and 110b, collectively referred to as 110) in the radio access network 100. Optionally, FIG. 1 is merely a diagram. The wireless communication system may further include another device, for example, may further include a core network device, a wireless relay device, and/or a wireless backhaul device, which are not shown in FIG. 1.

The following describes in detail the network device and the terminal device in FIG. 1.

The network device may be an entity configured to transmit or receive a signal on a network side. The network device may be an access device via which the terminal device accesses the wireless communication system in a wireless manner. For example, the network device may be a base station. The base station may broadly cover various names in the following, or may be replaced with the following name, for example, a NodeB, an evolved NodeB (eNB), a next generation NodeB (gNB), an access network device in an Open Radio Access Network (O-RAN), a relay station, an access point (AP), a transmitting and receiving point (TRP), a transmitting point (TP), a main station (MeNB), a secondary station (SeNB), a Multi-Standard Radio (MSR) node, a home base station, a network controller, an access node, a radio node, a transmission node, a transceiver node, a baseband unit (BBU), a remote radio unit (RRU), an active antenna unit (AAU), a remote radio head (RRH), a central unit (CU), a distributed unit (DU), a radio unit (RU), a central unit control plane (CU-CP) node, a central unit user plane (CU-UP) node, or a positioning node. The base station may be a macro base station, a micro base station, a relay node, a donor node, or the like, or a combination thereof. Alternatively, the network device may be a communication module, a modem, or a chip disposed in the foregoing device or apparatus. Alternatively, the network device may be a mobile switching center, a device that performs functions of a base station in D2D, V2X, and M2M communication, a network side device in a 6G network, a device that performs functions of a base station in a future communication system, or the like. The network device may support networks with a same access technology or different access technologies. A specific technology and a specific device form that are used by the network device are not limited in embodiments of this disclosure.

The network device may be stationary or mobile. For example, base stations 110a and 110b are stationary, and are responsible for wireless transmission and reception in one or more cells from the terminal device 120. A helicopter or an uncrewed aerial vehicle 120i shown in FIG. 1 may be configured to serve as a mobile base station, and one or more cells may move based on a position of the mobile base station 120i. In another example, the helicopter or the uncrewed aerial vehicle (120i) may be configured to serve as a terminal device communicating with the base station 110b.

The network device in embodiments of this disclosure may be an all-in-one base station, or may be a base station including a CU and/or a DU. The base station including the CU and the DU may also be referred to as a base station in which a CU and a DU are split from each other. For example, the base station includes a gNB-CU and a gNB-DU. The CU may be further split into a CU-CP and a CU-UP. For example, the base station includes a gNB-CU-CP, a gNB-CU-UP, and a gNB-DU. Alternatively, the network device in embodiments of this disclosure may be an RU. Alternatively, the network device in embodiments of this disclosure may be of an O-RAN architecture or the like. A specific deployment manner of the network device is not limited in embodiments of this disclosure. For example, when the network device is of the O-RAN architecture, the network device shown in embodiments of this disclosure may be an access network device in the O-RAN, for example, one or a combination of a CU, a DU, or an RU, or may be a module in the access network device. In an O-RAN system, a CU may also be referred to as an open (O)-CU, a CU-CP may also be referred to as an O-CU-CP, a CU-UP may also be referred to as an O-CU-UP, and an RU may also be referred to as an O-RU.

In this disclosure, a communication apparatus configured to implement a function of the access network may be an access network device, a network device having a part of functions of the access network, or an apparatus that can support implementation of the function of the access network, for example, a chip system, a hardware circuit, a software module, or a hardware circuit plus a software module. The apparatus may be mounted in the access network device or used together with the access network device. In the method in this disclosure, an example in which the communication apparatus configured to implement the function of the access network device is an access network device is used for description.

The terminal device may be an entity configured to receive or transmit a signal on a user side, for example, a mobile phone. The terminal device may be configured to connect to a person, an object, and a machine. The terminal device may communicate with one or more core networks via the network device. The terminal device includes a handheld device having a wireless connection function, another processing device connected to a wireless modem, a vehicle-mounted device, or the like. The terminal device may be a portable, pocket-sized, handheld, computer built-in, or vehicle-mounted mobile apparatus. The terminal device 120 may be widely used in various scenarios, for example, cellular communication, D2D, V2X, peer-to-peer (P2P), M2M, MTC, IoT, virtual reality (VR), augmented reality (AR), industrial control, autonomous driving, telemedicine, smart grids, smart furniture, smart offices, smart wearables, smart transportation, smart cities, uncrewed aerial vehicles, robots, remote sensing, passive sensing, positioning, navigation, autonomous delivery, and mobility. Some examples of the terminal device 120 are 3rd Generation Partnership Project (3GPP) standard user equipment (UE), a stationary device, a mobile device, a handheld device, a wearable device, a cellular phone, a smartphone, a Session Initiation Protocol (SIP) phone, a notebook computer, a personal computer, a smart book, a vehicle, a satellite, a Global Positioning System (GPS) device, a target tracking device, an uncrewed aerial vehicle, a helicopter, a flight, a ship, a remote management device, a smart home device, an industrial device, a personal communication service (PCS) phone, a wireless local loop (WLL) station, a personal digital assistant (PDA), a wireless network camera, a tablet computer, a palmtop computer, a mobile Internet device (MID), a wearable device such as a smartwatch, a VR device, an AR device, a wireless terminal in industrial control, a terminal in an Internet of vehicles system, a wireless terminal in self-driving, a wireless terminal in a smart grid, a wireless terminal in transportation safety, a wireless terminal in a smart city, for example, a smart fuel dispenser, a terminal device on a high-speed train, and a wireless terminal in a smart home, for example, a smart speaker, a smart coffee machine, or a smart printer. The terminal device 120 may be a wireless device in the foregoing scenarios or an apparatus configured to be disposed in the wireless device, for example, a communication module, a modem, or a chip in the foregoing device. The terminal device may also be referred to as a terminal, a terminal device, UE, a mobile station (MS), a mobile terminal (MT), or the like. Alternatively, the terminal device may be a terminal device in a future wireless communication system. The terminal device may be used in a dedicated network device or a general-purpose device. A specific technology and a specific device form that are used by the terminal device are not limited in embodiments of this disclosure.

Optionally, the terminal devices may communicate with each other by using sidelink signals. For example, as shown in FIG. 1, a cellular phone 120a and a car 120b communicate with each other by using sidelink signals. The cellular phone 120a communicates with a smart home device 120e without relaying a communication signal via the base station 110b.

In this disclosure, a communication apparatus configured to implement a function of the terminal device may be a terminal device, a terminal device having a part of functions of the terminal device, or an apparatus that can support implementation of the function of the terminal device, for example, a chip system. The apparatus may be mounted in the terminal device or used together with the terminal device. In this disclosure, the chip system may include a chip, or may include a chip and another discrete device. In the technical solutions provided in this disclosure, an example in which the communication apparatus is a terminal device or UE is used for description.

It should be noted that a quantity and types of devices in the communication system shown in FIG. 1 are merely used as examples. Embodiments of this disclosure are not limited thereto. In actual application, the communication system may further include more terminal devices and more network devices, and may further include another network element, for example, may include a core network element and a network management device such as an operation, administration, and maintenance (OAM) network element.

Further, FIG. 2 shows a structure of protocol layers between the network device and the terminal device. For functions of the protocol layers, refer to the following content for understanding:

A radio resource control (RRC) layer is used by the network device and the terminal device to send and receive RRC signaling. For example, the network device sends the RRC signaling to the terminal device, and the terminal device receives the RRC signaling from the network device.

A media access control (MAC) layer is used by the network device and the terminal device to send and receive MAC-control element (CE) signaling. For example, the network device sends the MAC-CE signaling to the terminal device, and the terminal device receives the MAC-CE signaling from the network device.

A physical layer (PHY) is used by the network device and the terminal device to send and receive uplink/downlink control signaling or uplink/downlink data. For example, the network device sends a physical downlink control channel (PDCCH), for example, downlink control information (DCI) in the PDCCH, to the terminal device, and the network device sends a physical downlink shared channel (PDSCH), for example, downlink data in the PDSCH, to the terminal device. The terminal device sends a physical uplink control channel (PUCCH), for example, uplink control information (UCI) in the PUCCH, to the network device, and the terminal device sends a physical uplink shared channel (PUSCH), for example, uplink data in the PUSCH, to the network device.

It should be understood that the modules shown in FIG. 2 are merely an example. The network device and the terminal device may further include another communication protocol layer, for example, a radio link control (RLC) layer, a Packet Data Convergence Protocol (PDCP) layer, or a Service Data Adaptation Protocol (SDAP) layer. This is not limited in embodiments of this disclosure. In addition, it may be understood that the foregoing protocol layers may belong to an access stratum (AS) between the terminal device and the network device. For example, the AS between the terminal device and the network device includes the RRC/SDAP layer, the PDCP layer, the RLC layer, the MAC layer, and the PHY layer.

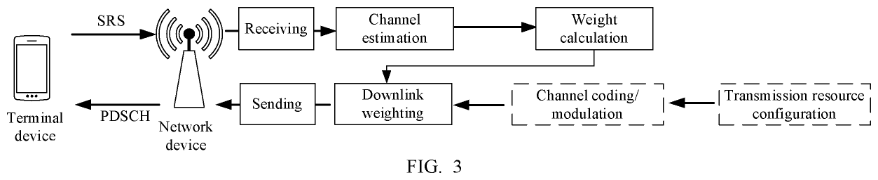

In a TDD system, through reciprocity between an uplink channel and a downlink channel, the network device may estimate uplink channel information based on a reference signal (for example, a sounding reference signal (SRS)) from the terminal device; and determine a downlink communication configuration based on the uplink channel information. For example, downlink weighting is performed with a weight calculated based on the uplink channel information, that is, precoding information to be used during transmission of downlink information is determined. The downlink information may include downlink data (for example, a PDSCH) or downlink control signaling (for example, DCI). For another example, a transmission resource, a channel coding parameter, or a modulation parameter of the downlink information may be determined based on the uplink channel information. For example, FIG. 3 shows a procedure in which the network device performs downlink weighting with the weight calculated based on the uplink channel information.

When the uplink and downlink channels in the TDD system are not ideally reciprocal, there is a large fading difference between the uplink channel and the downlink channel. Consequently, channel information of the uplink channel is inconsistent with that of the downlink channel, resulting in poor adaptability and accuracy of configuring communication of the downlink channel by using the channel information of the uplink channel.

In view of this, embodiments of this disclosure provide a communication method. Both communication parties preprocess their respective estimated channel information in a same manner, to improve consistency of channel information extracted by both communication parties. In embodiments of this disclosure, both communication parties may be denoted as a first communication apparatus and a second communication apparatus below. The first communication apparatus may preprocess first channel information from the second communication apparatus to the first communication apparatus, and configure communication of a channel from the first communication apparatus to the second communication apparatus based on a preprocessing result, so that adaptability and accuracy can be improved. The second communication apparatus may preprocess second channel information from the first communication apparatus to the second communication apparatus, and configure communication of a channel from the second communication apparatus to the first communication apparatus based on a preprocessing result, so that adaptability and accuracy can be improved.

It may be understood that the first channel information may be channel information estimated by the first communication apparatus based on a reference signal sent by the second communication apparatus, and the second channel information may be channel information estimated by the second communication apparatus based on a reference signal sent by the first communication apparatus.

The communication method provided in embodiments of this disclosure may be applied to a TDD system. In a first possible design, the first communication apparatus is a network device, or may be a communication apparatus that is used in the network device or used together with the network device and that can implement a communication method performed by the network device; and the second communication apparatus is a terminal device, or may be a communication apparatus that is used in the terminal device or used together with the terminal device and that can implement a communication method performed by the terminal device. In a second possible design, the first communication apparatus is a terminal device, or may be a communication apparatus that is used in the terminal device or used together with the terminal device and that can implement a communication method performed by the terminal device; and the second communication apparatus is a network device, or may be a communication apparatus that is used in the network device or used together with the network device and that can implement a communication method performed by the network device. In a third possible design, the first communication apparatus is a terminal device, or may be a communication apparatus that is used in the terminal device or used together with the terminal device and that can implement a communication method performed by the terminal device; and the second communication apparatus is a terminal device, or may be a communication apparatus that is used in the terminal device or used together with the terminal device and that can implement a communication method performed by the terminal device.

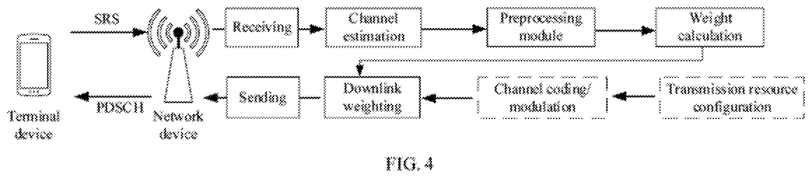

For example, the first communication apparatus is a network device, and the second communication apparatus is a terminal device. In FIG. 4, a preprocessing module is introduced between channel estimation and weight calculation shown in FIG. 3. The network device may preprocess channel information obtained through channel estimation, and then calculate a weight by using a preprocessing result to perform downlink weighting, so that adaptability and accuracy of configuring communication of a downlink channel by using channel information of an uplink channel can be improved.

The following describes in detail preprocessing manners of the first communication apparatus and the second communication apparatus with reference to the accompanying drawings.

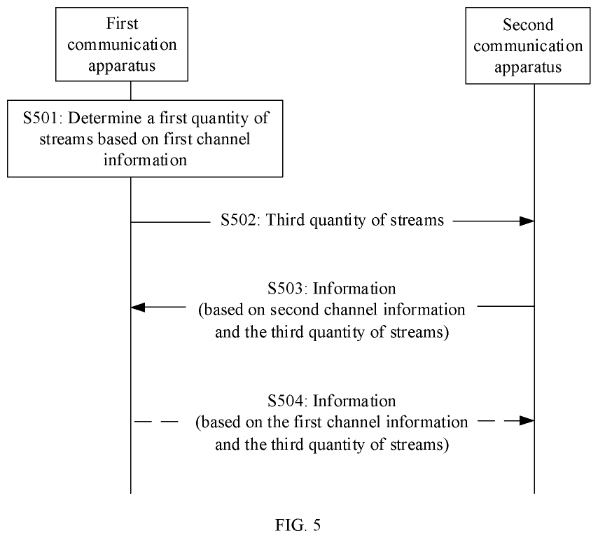

FIG. 5 shows a communication method. The method mainly includes the following procedure.
S501: A first communication apparatus determines a first quantity of streams based on first channel information.

In a possible design, the first communication apparatus may receive a reference signal from a second communication apparatus in real time, and estimate the first channel information based on the reference signal. In another possible design, the first communication apparatus may store channel information estimated based on the reference signal from the second communication apparatus. In this case, the first channel information may be the channel information stored in the first communication apparatus. Alternatively, this may be understood as that the first channel information is channel information historically estimated by the first communication apparatus.

In a possible implementation, the first channel information corresponds to Rank1 streams. Alternatively, this may be understood as that the first channel information is equivalent to channel information of Rank1 subchannels. Rank1 is a maximum quantity of streams corresponding to the first channel information. The first quantity of streams is less than or equal to the maximum quantity of streams corresponding to the first channel information.

The first communication apparatus may determine, based on a signal-to-noise ratio corresponding to the first channel information and a singular value of at least one stream in the Rank1 streams corresponding to the first channel information, a first condition that the first quantity of streams needs to satisfy; and then determine the first quantity of streams based on the first condition. It may be understood that the signal-to-noise ratio corresponding to the first channel information is a signal-to-noise ratio (SNR) of a channel from the second communication apparatus to the first communication apparatus.

In a possible design, the first communication apparatus may determine the first condition based on the signal-to-noise ratio corresponding to the first channel information and a singular value of a primary stream of the first channel information. The first condition is that a ratio of the singular value of the primary stream of the first channel information to a singular value of an i^{th} stream in singular values of L1 streams of the first channel information is less than or equal to a first threshold. The first threshold is determined based on the signal-to-noise ratio corresponding to the first channel information. i is an integer from 1 to L1. A value of the first quantity of streams is L1. It may be understood that the singular value of the primary stream of the first channel information is the largest.

Optionally, the signal-to-noise ratio of the first channel information is

$$SNR 1 = 10 \cdot {log}_{10} ( \frac{{P}_{signal}}{{P}_{noise}} ) .$$

P_{signal} is an average power of a signal. Pₙₒᵢₛₑ is an average power In a process of performing channel estimation to obtain the first channel information, the first communication apparatus may obtain spectrum information Θ of the channel and spectrum information γ of the noise. In a complex Gaussian condition, the average power P_{signal} of the signal may be replaced with θ, and the average power Pₙₒᵢₛₑ of the noise may be replaced with γ, that is,

$$SNR 1 = 10 \cdot {log}_{10} ( \frac{Θ}{γ} ) .$$

In embodiments of this disclosure,

$$\frac{Θ}{γ}$$

is used as the first threshold, and the first condition may be expressed as

$$\frac{{σ}_{1}}{{σ}_{i}} \leq \frac{Θ}{γ} .$$

Alternatively, if rᵢ represents

$$\frac{{σ}_{i}}{{σ}_{1}} ,$$

the first condition may be expressed as

$$\frac{{r}_{i} Θ}{γ} \geq 1 .$$

σ₁ indicates the singular value of the primary stream of the first channel information. σᵢ indicates the singular value of the i^{th} stream in the L1 streams of the first channel information. If H_{ba} indicates the first channel information, σ₁ may alternatively be described as σ₁(H_{ba}), and σᵢ may alternatively be described as σᵢ(H_{ba}).

In addition, optionally, when singular values of the Rank1 streams of the first channel information are arranged in descending order, a 1^{st} stream of the first channel information is the primary stream. If a ratio of a singular value of the 1^{st} stream and a singular value of an L1^{st} stream of the first channel information is less than or equal to the first threshold, but a ratio of the singular value of the 1^{st} stream and a singular value of an (L1+1)^{th} stream of the first channel information are greater than the first threshold, the first communication apparatus may determine that the value of the first quantity of streams is L1. The first condition may be expressed as

$$\frac{{σ}_{1}}{{σ}_{L 1}} \leq \frac{Θ}{γ} .$$

Alternatively, if r_{L1} represents

$$\frac{{σ}_{L 1}}{{σ}_{1}} ,$$

the first condition may be expressed as

$$\frac{{r}_{L 1} θ}{γ} \geq 1 .$$

σ_{L1} indicates the singular value of the L1^{th} stream in the L1 streams of the first channel information. If H_{ba} indicates the first channel information, σ_{L1} may alternatively be described as σ_{L1}(H_{ba}).

In this design, channel information of the L1 streams with high channel energy may be extracted from the Rank1 streams, to improve a channel expression capability.
S502: The first communication apparatus indicates a third quantity of streams to the second communication apparatus.

The third quantity of streams is less than or equal to the first quantity of streams. If L indicates the third quantity of streams and L1 indicates the first quantity of streams, some examples of a value of the third quantity of streams are as follows: L=1, and L streams are the primary stream of the first channel information; or L=L1; or L=f(L1,1)=Lᵤ₁∈[1, L1].
S503: The second communication apparatus sends information to the first communication apparatus based on second channel information and the third quantity of streams.

In a possible design, the second communication apparatus may receive a reference signal from the first communication apparatus in real time, and estimate the second channel information based on the reference signal. In another possible design, the second communication apparatus may store channel information estimated based on the reference signal from the first communication apparatus. In this case, the second channel information may be the channel information stored in the second communication apparatus. Alternatively, this may be understood as that the second channel information is channel information historically estimated by the second communication apparatus.

The second communication apparatus searches singular values of Rank2 streams of the second channel information for singular values of L streams based on the third quantity (L) of streams that is indicated by the first communication apparatus. The singular values of the L streams are greater than the singular values of the Rank2 streams except the L streams. Rank2 is a maximum quantity of streams corresponding to the second channel information. In a possible implementation, the maximum quantity of streams corresponding to the second channel information is the same as the maximum quantity of streams corresponding to the first channel information.

In a possible implementation, the second communication apparatus determines second communication configuration information based on the singular values of the L streams of the second channel information and a weight coefficient corresponding to each piece of singular value information in the singular values of the L streams. The second communication configuration information includes one or more of precoding information, a channel coding parameter, or a modulation (scrambling) parameter. Then, the second communication apparatus sends the information to the first communication apparatus based on the second communication configuration information.

Weight coefficients corresponding to all pieces of singular value information in the singular values of the L streams may be the same or different. For example, the weight coefficients corresponding to the singular values of the L streams are all w. w may be 1. Alternatively, a weight coefficient corresponding to a singular value of an l^{th} stream in the L streams is wₗ. Different values of l correspond to different values of wₗ. l is an integer from 1 to L. Alternatively, weight coefficients corresponding to at least two singular values in the singular values of the L streams are the same. Optionally, the weight coefficient corresponding to each piece of singular value information in the singular values of the L streams may be predefined, or may be determined by the first communication apparatus and the second communication apparatus through negotiation in advance, or may be indicated by the first communication apparatus to the second communication apparatus.

An example in which the weight coefficient corresponding to the singular value of the l^{th} stream in the L streams is wₗ is used. First, the second communication apparatus may determine a second parameter

$$ℒ ( {H}_{ab} ) = {\sum }_{l = 1}^{L} {w}_{l} * {σ}_{l} ( {H}_{ab} )$$

based on the singular values of the L streams of the second channel information and the weight coefficient corresponding to each piece of singular value information in the singular values of the L streams. Then, the second communication apparatus may determine the second communication configuration information by using quantization information of [symbol] (H_{ab}). In this design, consistency of extracted channel information can be improved based on the same quantity L of streams. In addition, determining precoding, the channel coding parameter, the modulation parameter, or the like by leveraging the consistency of the extracted information can enhance a matching degree between the determined information and a channel state, and improve communication performance.

In addition, optionally, the second communication apparatus may further configure, by using the quantization information of the second parameter [symbol] (H_{ab}), a transmission resource that the second communication apparatus occupies to send the information to the first communication apparatus, for example, a time domain resource or a frequency domain resource. In other words, the second communication configuration information may further include a transmission resource of the second communication apparatus.

Similarly, FIG. 5 also shows step S504 by using a dashed line, indicating that step S504 is an optional step, and may be performed or may not be performed.
S504: The first communication apparatus may send information to the second communication apparatus based on the first channel information and the third quantity of streams.

In a possible implementation, the first communication apparatus determines first communication configuration information based on singular values of L streams of the first channel information and a weight coefficient corresponding to each piece of singular value information in the singular values of the L streams. The first communication parameter includes one or more of precoding information, a channel coding parameter, or a modulation (scrambling) parameter. Then, the first communication apparatus sends the information to the second communication apparatus based on the first communication configuration information.

For a definition of the singular values of the L streams, refer to the description in S503 for understanding. Details are not described again in embodiments of this disclosure. An example in which the weight coefficient corresponding to the singular value of the l^{th} stream in the L streams is wₗ is used. First, the first communication apparatus may determine a first parameter

$$ℒ ( {H}_{ba} ) = {\sum }_{l = 1}^{L} {w}_{l} * {σ}_{l} ( {H}_{ba} )$$

based on the singular values of the L streams of the first channel information and the weight coefficient corresponding to each piece of singular value information in the singular values of the L streams. Next, the first communication apparatus may determine the first communication configuration information by using quantization information of [symbol] (H_{ba}). Then, the first communication apparatus sends the information to the second communication apparatus by using the first communication configuration information. In addition, optionally, the first communication apparatus may further configure, by using the quantization information of the first parameter [symbol] (H_{ba}), a transmission resource that the first communication apparatus occupies to send the information to the second communication apparatus, for example, a time domain resource or a frequency domain resource. In other words, the first communication configuration information may further include a transmission resource of the first communication apparatus.

In the foregoing method provided in embodiments of this disclosure, the first communication apparatus determines the quantity L of streams used to preprocess the channel information. The first communication apparatus and the second communication apparatus use the same quantity L of streams to preprocess the channel information, so that the consistency of the information extracted by both communication parties can be improved.

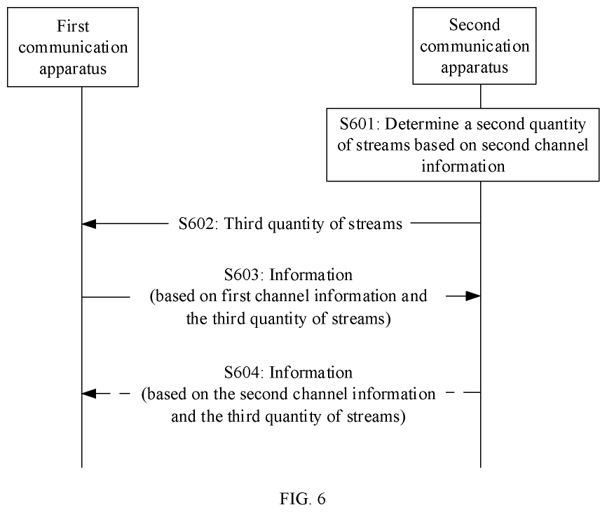

It may be understood that in FIG. 5, a possible implementation is described by using an example in which the first communication apparatus determines the quantity L of streams used to preprocess the channel information. Similar to FIG. 5, in another possible implementation, the second communication apparatus may determine the quantity L of streams used to preprocess the channel information. For ease of implementation, an example in which the second communication apparatus determines the quantity L of streams used to preprocess the channel information is used for description in FIG. 6. In addition, optionally, in actual communication, a computational power or resource of a communication apparatus determining the quantity L of streams is greater than that of a communication apparatus receiving an indication of the quantity L of streams.

FIG. 6 shows a communication method. The method mainly includes the following procedure.
S601: A second communication apparatus determines a second quantity of streams based on second channel information.

In a possible design, the second communication apparatus may receive a reference signal from a first communication apparatus in real time, and estimate the second channel information based on the reference signal. In another possible design, the second communication apparatus may store channel information estimated based on a reference signal from the first communication apparatus. In this case, the second channel information may be the channel information stored in the second communication apparatus. Alternatively, this may be understood as that the second channel information is channel information historically estimated by the second communication apparatus.

In a possible implementation, the second channel information corresponds to Rank2 streams. Alternatively, this may be understood as that the second channel information is equivalent to channel information of Rank2 subchannels. Rank2 is a maximum quantity of streams corresponding to the second channel information. The second quantity of streams is less than or equal to the maximum quantity of streams corresponding to the second channel information.

The second communication apparatus may determine, based on a signal-to-noise ratio corresponding to the second channel information and a singular value of at least one stream in the Rank2 streams corresponding to the second channel information, a second condition that the second quantity of streams needs to satisfy; and then determine the second quantity of streams based on the second condition. It may be understood that the signal-to-noise ratio corresponding to the second channel information is a signal-to-noise ratio of a channel from the first communication apparatus to the second communication apparatus, and is denoted as SNR2.

In a possible design, the second communication apparatus may determine the second condition based on the signal-to-noise ratio corresponding to the second channel information and a singular value of a primary stream of the second channel information. The second condition is that a ratio of the singular value of the primary stream of the second channel information to a singular value of a j^{th} stream in singular values of L2 streams of the second channel information is less than or equal to a second threshold. The second threshold is determined based on the signal-to-noise ratio corresponding to the second channel information. j is an integer from 1 to L2. A value of the second quantity of streams is L2. It may be understood that the singular value of the primary stream of the second channel information is the largest.

Optionally, the signal-to-noise ratio of the second channel information is

$$SNR 2 = 10 \cdot {log}_{10} ( \frac{{P}_{signal}}{{P}_{noise}} ) .$$

P_{signal} is an average power of the signal. Pₙₒᵢₛₑ is an average power of noise. In a process of performing channel estimation to obtain the second channel information, the second communication apparatus may obtain spectrum information Θ of the channel and spectrum information γ of the noise. In a complex Gaussian condition, the average power P_{signal} of the signal may be replaced with θ, and the average power Pₙₒᵢₛₑ of the noise may be replaced with γ, yielding

$$SNR 2 = 10 \cdot {log}_{10} ( \frac{Θ}{γ} ) .$$

In embodiments of this disclosure,

$$\frac{Θ}{γ}$$

is used as the second threshold, and the second condition may be expressed as

$$\frac{{σ}_{1}}{{σ}_{j}} \leq \frac{Θ}{γ} .$$

Alternatively, if rⱼ represents

$$\frac{{σ}_{j}}{{σ}_{1}} ,$$

the second condition may be expressed as

$$\frac{{r}_{j} Θ}{γ} \geq 1. {σ}_{1}$$

indicates the singular value of the primary stream of the second channel information. σⱼ indicates the singular value of the j^{th} stream in the L2 streams of the second channel information. If H_{ab} indicates the second channel information, σ₁ may alternatively be described as σ₁(H_{ab}), and σⱼ may alternatively be described as σⱼ(H_{ab}).

In addition, optionally, when singular values of the Rank2 streams of the second channel information are arranged in descending order, a 1^{st} stream of the second channel information is the primary stream. If a ratio of a singular value of the 1^{st} stream and a singular value of an L2^{th} stream of the second channel information is less than or equal to the second threshold, but a ratio of the singular value of the 1^{st} stream and a singular value of an (L2+1)^{th} stream of the second channel information are greater than the second threshold, the second communication apparatus may determine that the value of the second quantity of streams is L2. The second condition may be expressed as

$$\frac{{σ}_{1}}{{σ}_{L 2}} \leq \frac{Θ}{γ} .$$

Alternatively, if r_{L2} represents

$$\frac{{σ}_{L 2}}{{σ}_{1}} ,$$

the second condition may be expressed as

$$\frac{{r}_{L 2} Θ}{γ} \geq 1 .$$

σ_{L2} indicates the singular value of the L2^{th} stream in the L2 streams of the second channel information. If H_{ab} indicates the second channel information, σ_{L2} may alternatively be described as σ_{L2}(H_{ab}).

In this design, channel information of the L2 streams with high channel energy may be extracted from the Rank2 streams, to improve a channel expression capability.
S602: The second communication apparatus indicates a third quantity of streams to the first communication apparatus.

The third quantity of streams is less than or equal to the second quantity of streams. If L indicates the third quantity of streams and L2 indicates the second quantity of streams, some examples of a value of the third quantity of streams are as follows: L=1, and L streams are the primary stream of the second channel information; or L=L2; or L=f(L2,1)=L₁∈[1, L2].
S603: The first communication apparatus sends information to the second communication apparatus based on first channel information and the third quantity of streams.

In a possible design, the first communication apparatus may receive a reference signal from the second communication apparatus in real time, and estimate the first channel information based on the reference signal. In another possible design, the first communication apparatus may store channel information estimated based on a reference signal from the second communication apparatus. In this case, the first channel information may be the channel information stored in the first communication apparatus. Alternatively, this may be understood as that the first channel information is channel information historically estimated by the first communication apparatus.

The first communication apparatus searches singular values of Rank1 streams of the first channel information for singular values of L streams based on the third quantity (L) of streams that is indicated by the second communication apparatus. The singular values of the L streams are greater than the singular values of the Rank1 streams except the L streams. Rank1 is a maximum quantity of streams corresponding to the first channel information.

In a possible implementation, the first communication apparatus determines first communication configuration information based on the singular values of the L streams of the first channel information and a weight coefficient corresponding to each piece of singular value information in the singular values of the L streams. Then, the first communication apparatus sends the information to the second communication apparatus by using the first communication configuration information. For implementation, refer to the description in S504. Details are not described again in embodiments of this disclosure.

Similarly, FIG. 6 also shows step S604 by using a dashed line, indicating that step S604 is an optional step, and may be performed or may not be performed.
S604: The second communication apparatus may send information to the first communication apparatus based on the second channel information and the third quantity of streams.

In a possible implementation, the second communication apparatus determines second communication configuration information based on singular values of L streams of the second channel information and a weight coefficient corresponding to each piece of singular value information in the singular values of the L streams. Then, the second communication apparatus sends the information to the first communication apparatus by using the second communication configuration information. For implementation, refer to the description in S503. Details are not described again in embodiments of this disclosure.

In the foregoing method provided in embodiments of this disclosure, the second communication apparatus determines the quantity L of streams used to preprocess the channel information. The first communication apparatus and the second communication apparatus use the same quantity L of streams to preprocess the channel information, so that the consistency of the information extracted by both communication parties can be improved.

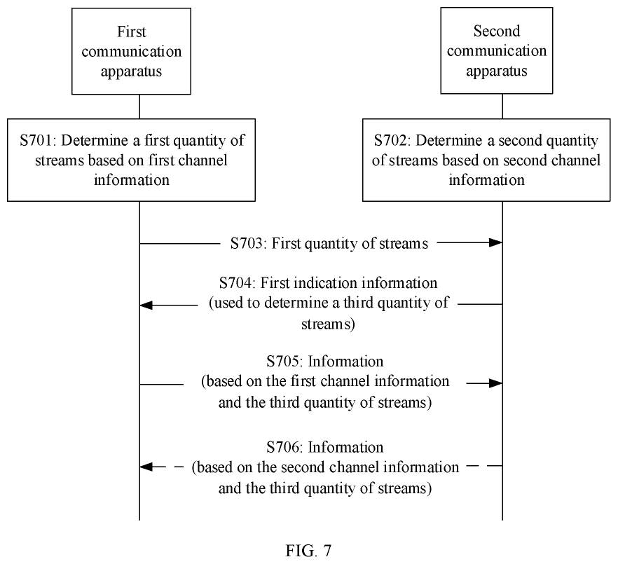

FIG. 7 shows a communication method. The method mainly includes the following procedure.
S701: A first communication apparatus determines a first quantity of streams based on first channel information.

For implementation of this step, refer to S501. Details are not described again in embodiments of this disclosure.
S702: A second communication apparatus determines a second quantity of streams based on second channel information.

For implementation of this step, refer to S601. Details are not described again in embodiments of this disclosure.
S703: The first communication apparatus indicates the first quantity of streams to the second communication apparatus.
S704: The second communication apparatus sends first indication information to the first communication apparatus.

In a possible implementation, if the second communication apparatus determines that the second quantity of streams is the same as the received first quantity of streams, the second communication apparatus may determine that a third quantity of streams is the first quantity of streams or the second quantity of streams. Further, the first indication information sent by the second communication apparatus to the first communication apparatus may indicate that the second quantity of streams is the same as the first quantity of streams. For example, the first indication information includes a consistency indicator. A value of the consistency indicator is a first value, indicating that the first quantity of streams is the same as the second quantity of streams.

In another possible implementation, if the second communication apparatus determines that the second quantity of streams is different from the received first quantity of streams, the second communication apparatus may determine the third quantity of streams based on the first quantity of streams and the second quantity of streams. Optionally, the third quantity of streams is less than or equal to the smaller one of the first quantity of streams and the second quantity of streams. For example, if L1 indicates the first quantity of streams and L2 indicates the second quantity of streams, the third quantity of streams is as follows: L=1; or L=f(L₁, L₂)=Lₘᵢₙ =min{L₁, L₂}; or L=f(L₁, L₂)=Lᵤ∈[1, Lₘᵢₙ]. Further, the first indication information sent by the second communication apparatus to the first communication apparatus may indicate the third quantity of streams. Optionally, in this case, the first indication information may further include a consistency indicator. A value of the consistency indicator is a second value, indicating that the first quantity of streams is different from the second quantity of streams. It may be understood that the first value is different from the second value. For example, the consistency indicator may occupy one bit. The first value is 0, and the second value is 1. Alternatively, the first value is 1, and the second value is 0.
S705: The first communication apparatus sends information to the second communication apparatus based on the first channel information and the third quantity of streams.

The first communication apparatus may determine the third quantity of streams based on the first indication information received in S704. For example, if the first indication information indicates that the first quantity of streams is the same as the second quantity of streams, the first communication apparatus may determine that the third quantity of streams is the first quantity of streams. For another example, if the first indication information indicates the third quantity of streams, the first communication apparatus may determine the third quantity of streams based on the first indication information.

For implementation of this step, refer to S504 or S603. Details are not described again in embodiments of this disclosure.

Similarly, FIG. 7 also shows step S705 by using a dashed line, indicating that step S705 is an optional step, and may be performed or may not be performed.
S706: The second communication apparatus may send information to the first communication apparatus based on the second channel information and the third quantity of streams.

Corresponding to the description in S704, it may be understood that if the first quantity of streams is the same as the second quantity of streams, the second communication apparatus may determine that the third quantity of streams is the second quantity of streams or the first quantity of streams. If the first quantity of streams is different from the second quantity of streams, the second communication apparatus determines the third quantity of streams by itself. The third quantity of streams is less than or equal to the smaller one of the first quantity of streams and the second quantity of streams.

For implementation of this step, refer to S503 or S604. Details are not described again in embodiments of this disclosure.

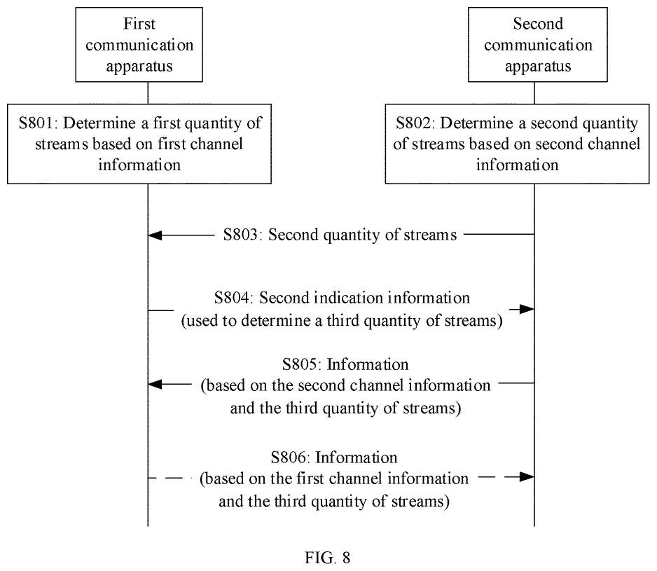

It may be understood that in FIG. 7, a possible implementation is described by using an example in which the second communication apparatus determines whether the first quantity of streams is the same as the second quantity of streams. Similar to FIG. 7, FIG. 8 shows another possible implementation, in which the first communication apparatus determines whether the first quantity of streams is the same as the second quantity of streams.

FIG. 8 shows a communication method. The method mainly includes the following procedure.
S801: A first communication apparatus determines a first quantity of streams based on first channel information.

For implementation of this step, refer to S501. Details are not described again in embodiments of this disclosure.
S802: A second communication apparatus determines a second quantity of streams based on second channel information.

For implementation of this step, refer to S601. Details are not described again in embodiments of this disclosure.
S803: The second communication apparatus indicates the second quantity of streams to the first communication apparatus.
S804: The first communication apparatus sends second indication information to the second communication apparatus.

In a possible implementation, if the first communication apparatus determines that the first quantity of streams is the same as the received second quantity of streams, the first communication apparatus may determine that a third quantity of streams is the second quantity of streams or the first quantity of streams. Further, the second indication information sent by the first communication apparatus to the second communication apparatus may indicate that the first quantity of streams is the same as the second quantity of streams. For example, the second indication information includes a consistency indicator. A value of the consistency indicator is a first value, indicating that the first quantity of streams is the same as the second quantity of streams.

In another possible implementation, if the first communication apparatus determines that the first quantity of streams is different from the received second quantity of streams, the first communication apparatus may determine the third quantity of streams based on the second quantity of streams and the first quantity of streams. Optionally, the third quantity of streams is less than or equal to the smaller one of the second quantity of streams and the first quantity of streams. For example, if L1 indicates the second quantity of streams and L2 indicates the first quantity of streams, the third quantity of streams is as follows: L=1; or L=f(L₁, L₂)=Lₘᵢₙ=min{L₁, L₂}; or L=f(L₁, L₂)=Lᵤ∈[1, Lₘᵢₙ]. Further, the second indication information sent by the first communication apparatus to the second communication apparatus may indicate the third quantity of streams. Optionally, in this case, the second indication information may further include a consistency indicator. A value of the consistency indicator is a second value, indicating that the first quantity of streams is different from the second quantity of streams. It may be understood that the first value is different from the second value. For example, the consistency indicator may occupy one bit. The first value is 0, and the second value is 1. Alternatively, the first value is 1, and the second value is 0.
S805: The second communication apparatus sends information to the first communication apparatus based on the second channel information and the third quantity of streams.

The second communication apparatus may determine the third quantity of streams based on the second indication information received in S804. For example, if the second indication information indicates that the second quantity of streams is the same as the first quantity of streams, the second communication apparatus may determine that the third quantity of streams is the second quantity of streams. For another example, if the second indication information indicates the third quantity of streams, the second communication apparatus may determine the third quantity of streams based on the second indication information.

For implementation of this step, refer to S503 or S604. Details are not described again in embodiments of this disclosure.

Similarly, FIG. 8 also shows step S806 by using a dashed line, indicating that step S806 is an optional step, and may be performed or may not be performed.
S806: The first communication apparatus may send information to the second communication apparatus based on the first channel information and the third quantity of streams.

Corresponding to the description in S804, it may be understood that if the second quantity of streams is the same as the first quantity of streams, the first communication apparatus may determine that the third quantity of streams is the first quantity of streams or the second quantity of streams. If the second quantity of streams is different from the first quantity of streams, the first communication apparatus determines the third quantity of streams by itself. The third quantity of streams is less than or equal to the smaller one of the second quantity of streams and the first quantity of streams.

For implementation of this step, refer to S504 or S603. Details are not described again in embodiments of this disclosure.

In the foregoing method shown in FIG. 7 or FIG. 8 and provided in embodiments of this disclosure, the quantity L of streams used to preprocess the channel information is determined on a basis of the quantities of streams separately determined by both communication parties based on singular values of the channel information. The first communication apparatus and the second communication apparatus use the same quantity L of streams to preprocess the channel information, so that consistency of information extracted by both communication parties can be improved. In addition, optionally, the method shown in FIG. 7 or FIG. 8 may be further applied to a communication scenario in which both communication parties have a same computational power or resource, for example, communication between terminal devices.

For example, the method described in any one of the embodiments in FIG. 5 to FIG. 8 is applied to a TDD system. An example in which the first communication apparatus is a network device and the second communication apparatus is a terminal device is used. If the first communication apparatus and the second communication apparatus establish a bidirectional communication connection, the first channel information (H_{ba}) and the second channel information (H_{ab}) satisfy the following relation: H_{ab}=H_{ba}+E. H_{ab} and H_{ba} may be matrices. h is an element in the matrix H_{ab} or H_{ba}. h satisfies a Gaussian distribution corresponding to Θ× [symbol] [symbol] (0,1). Θ indicates large-scale fading of a channel between the first communication apparatus and the second communication apparatus. [symbol] [symbol] (0,1) indicates small-scale fading of the channel. E indicates noise, and may also be a matrix. e is an element in the matrix E. e satisfies a Gaussian distribution corresponding to additive white Gaussian noise [symbol] [symbol] (0, γ²). A noise part of [symbol] [symbol] (0, γ²) is determined based on a signal-to-noise ratio of the channel.

The first channel information (H_{ba}) and the second channel information (H_{ab}) are preprocessed based on the third quantity L of streams to obtain the first parameter [symbol] (H_{ba}) and the second parameter [symbol] (H_{ab}), which satisfy the following relation:

$$\vert ℒ ( {H}_{ab} ) - ℒ ( {H}_{ba} ) \vert = \vert {\sum }_{l = 1}^{L} {w}_{l} * {σ}_{l} ( {H}_{ab} ) - {\sum }_{l = 1}^{L} {w}_{l} * {σ}_{l} ( {H}_{ba} ) \vert \leq {\sum }_{l = 1}^{L} {w}_{l} * {σ}_{1} ( E ) = UB ,$$

to improve the consistency of the extracted channel information. σ₁(E) may be understood as a spectral coefficient of the matrix E.

However, there is no bidirectional communication connection between channels from the terminal device to different network devices, and a difference between channel information of the channels is greater than E. For example, the terminal device sends SRSs to two network devices. The two network devices perform channel estimation based on the SRSs to obtain respective first channel information. For ease of differentiation, the two pieces of first channel information are denoted as H_{ba} and H′_{ba}. The two network devices preprocess the respective estimated first channel information based on the third quantity L of streams to obtain the first parameter [symbol] (H_{ba}) and a third parameter [symbol] (H′_{ba}). A difference between the first parameter [symbol] (H_{ba}) and the third parameter [symbol] (H′_{ba}) is greater than UB. The first parameter [symbol] (H_{ba}) and the third parameter [symbol] (H′_{ba}) satisfy the following relation:

$$\vert ℒ ( {H}_{ba} ) - ℒ ( {H}_{ba}^{′} ) \vert = \vert {\sum }_{l = 1}^{L} {w}_{l} * {σ}_{l} ( {H}_{ba} ) - {\sum }_{l = 1}^{L} {w}_{l} * {σ}_{l} ( {H}_{ba}^{′} ) \vert \geq \frac{{r}_{L} Θ}{γ} * {\sum }_{l = 1}^{L} {w}_{l} * {σ}_{1} ( E ) + φ \cdot LB = \frac{{r}_{L} Θ}{γ} * {\sum }_{l = 1}^{L} {w}_{l} * {σ}_{1} ( E ) + φ$$

is used as an example. Because

$$UB = {\sum }_{l = 1}^{L} {w}_{l} * {σ}_{1} ( E )$$

as described above,

$$LB = \frac{{r}_{L} Θ}{γ} * UB + φ \frac{{r}_{L} Θ}{γ} \geq 1 \cdot φ$$

is a real number greater than 0. It may be understood that LB>UB. It can be learned that when the method described in any one of the embodiments in FIG. 5 to FIG. 8 is applied to a TDD downlink precoding scenario, adaptability of a weight calculated by the network device based on an uplink channel to a downlink channel can be improved by leveraging the consistency of the extracted channel information. In addition, a difference between the channels from the terminal device to different network devices can be ensured based on a feature of LB>UB, to reduce information interference between different receivers (network devices).

In addition, it may be understood that for channel information of some channels in an FDD system, for example, channel information (Hᵤₗ) of an uplink statistical channel and channel information (H_{dl}) of a downlink statistical channel satisfy the following relation: H_{dl}=Hᵤₗ+E. For such channel information in FDD, the foregoing methods in FIG. 5 to FIG. 8 can also be used to extract channel information, so that consistency of the extracted channel information can be improved.

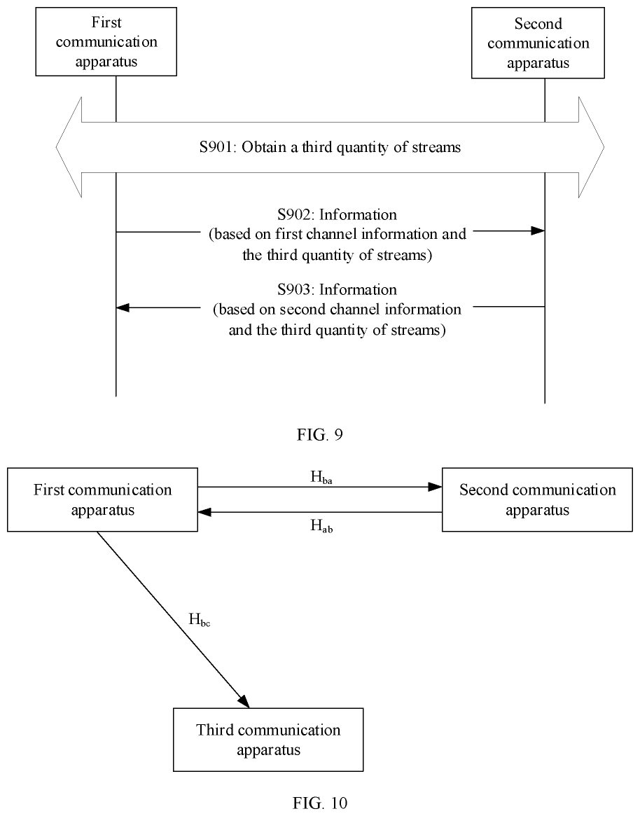

Based on the foregoing methods shown in FIG. 5 to FIG. 8, embodiments of this disclosure further provide a communication method. As shown in FIG. 9, the method includes the following procedure.
S901: A first communication apparatus and a second communication apparatus obtain a third quantity of streams.

The third quantity of streams is determined based on a first quantity of streams and/or a second quantity of streams. The first quantity of streams is determined based on first channel information from the second communication apparatus to the first communication apparatus. The second quantity of streams is determined based on second channel information from the first communication apparatus to the second communication apparatus. The third quantity of streams is less than or equal to a maximum quantity of streams corresponding to the first channel information (or second channel information).

For implementation, refer to S501 and S502 in FIG. 5; or refer to S601 and S602 in FIG. 6; or refer to S701 to S704 in FIG. 7; or refer to S801 to S804 in FIG. 8.
S902: The first communication apparatus sends information to the second communication apparatus based on the first channel information and the third quantity of streams.

For implementation of this step, refer to S504 or S603. Details are not described again in embodiments of this disclosure.
S903: The second communication apparatus sends information to the first communication apparatus based on the second channel information and the third quantity of streams.

For implementation of this step, refer to S503 or S604. Details are not described again in embodiments of this disclosure.

Further, the foregoing method provided in embodiments of this disclosure may be further applied to an encrypted communication scenario. For example, FIG. 10 shows that the first communication apparatus and the second communication apparatus are authorized communication parties. For example, the second communication apparatus is a sending apparatus, and the first communication apparatus is a receiving apparatus. An unauthorized third communication apparatus may obtain information of the second communication apparatus.

A bidirectional communication connection is established between the authorized communication parties. The first channel information (H_{ba}) estimated by the first communication apparatus and the second channel information (H_{ab}) estimated by the second communication apparatus satisfy the following relation: H_{ab}=H_{ba} +E. For the unauthorized third communication apparatus, the third communication apparatus may obtain the information of the second communication apparatus based on a channel from the second communication apparatus to the third communication apparatus. However, there is no channel from the third communication apparatus to the second communication apparatus. In other words, the second communication apparatus cannot obtain information of the third communication apparatus. No bidirectional communication connection is established between the second communication apparatus and the third communication apparatus, and the foregoing relation is not satisfied. Therefore, the first channel information (H_{ba}) estimated by the first communication apparatus and third channel information (H_{bc}) estimated by the third communication apparatus based on a reference signal from the second communication apparatus do not satisfy the foregoing relation.

According to this relation, a key for encrypted communication between the first communication apparatus and the second communication apparatus may be determined based on a first parameter and a second parameter that are obtained through preprocessing in the foregoing methods. For example, for authorized communication apparatuses (the first communication apparatus and the second communication apparatus), the first parameter [symbol] (H_{ba}) and the second parameter [symbol] (H_{ab}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) = UB .$$

In other words, there is a small difference between [symbol] (H_{ab}) and [symbol] (H_{ba}). Based on this feature, quantization information of [symbol] (H_{ab}) and quantization information of [symbol] (H_{ba}) may be considered as same information. Therefore, a key generated based on the quantization information of [symbol] (H_{ab}) is the same as a key generated based on the quantization information of [symbol] (H_{ba}). This can improve adaptability and consistency of channel information extracted by the authorized communication parties, to implement encrypted communication between the authorized communication parties.

Correspondingly, for the first communication apparatus and the third communication apparatus, the first communication apparatus obtains H_{ba} by performing channel estimation based on a reference signal obtained from the second communication apparatus, and the third communication apparatus obtains H_{bc} by performing channel estimation based on the reference signal obtained from the second communication apparatus. A difference between H_{ba} and H_{bc} is greater than E. The first communication apparatus may obtain the first parameter [symbol] (H_{ba}) by preprocessing, based on the third quantity L of streams, the channel information estimated by the first communication apparatus. The third communication apparatus may obtain a fourth parameter [symbol] (H_{bc}) by preprocessing, based on the third quantity L of streams, the channel information estimated by the third communication apparatus. The first parameter [symbol] (H_{ba}) and the fourth parameter [symbol] (H_{bc}) satisfy the following relation:

$$\vert ℒ ( {H}_{ba} ) - ℒ ( {H}_{bc} ) \vert \geq \frac{{r}_{L} Θ}{γ} {\sum }_{l = 1}^{L} {w}_{l} * {σ}_{1} ( E ) + φ = LB .$$

It may be understood that LB>UB. In other words, there is a large difference between [symbol] (H_{ba}) and [symbol] (H_{bc}). Based on this feature, there is still a specific difference between the quantization information of [symbol] (H_{ba}) and quantization information of [symbol] (H_{bc}). Therefore, a key generated based on the quantization information of [symbol] (H_{ba}) is different from a key generated based on the quantization information of [symbol] (H_{bc}). In other words, the unauthorized communication apparatus cannot obtain a communication key between the authorized communication parties, and secure communication between the communication parties can be ensured.

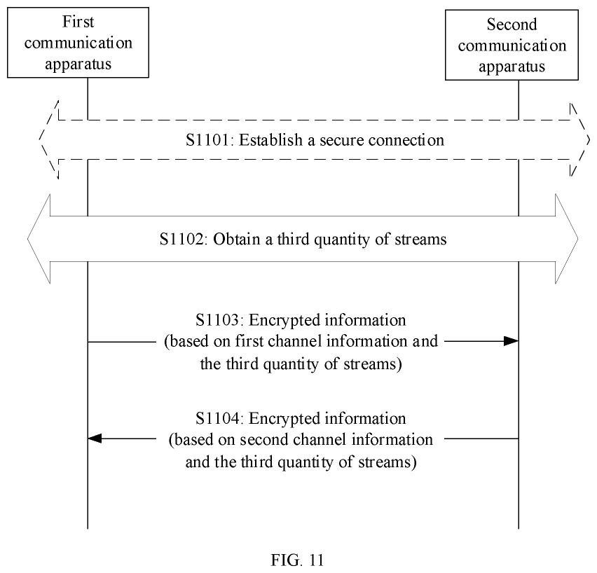

FIG. 11 shows a communication method. The method mainly includes the following procedure.
S1101: A first communication apparatus and a second communication apparatus establish a secure connection.

For example, in a TDD system, the first communication apparatus is a network device and the second communication apparatus is a terminal device. An AS security mode connection may be established between the first communication apparatus and the second communication apparatus. In addition, it may be understood that S1101 is an optional step. S1102 may be performed after S1101 is performed, or S1102 may be directly performed without performing S1101.
S1102: The first communication apparatus and the second communication apparatus obtain a third quantity of streams.

The third quantity of streams is determined based on a first quantity of streams and/or a second quantity of streams. The first quantity of streams is determined based on first channel information from the second communication apparatus to the first communication apparatus. The second quantity of streams is determined based on second channel information from the first communication apparatus to the second communication apparatus. The third quantity of streams is less than or equal to a maximum quantity of streams corresponding to the first channel information (or second channel information).

For implementation, refer to S501 and S502 in FIG. 5; or refer to S601 and S602 in FIG. 6; or refer to S701 to S704 in FIG. 7; or refer to S801 to S804 in FIG. 8.
S1103: The first communication apparatus sends encrypted information to the second communication apparatus based on the first channel information and the third quantity of streams.

First, the first communication apparatus determines first communication configuration information based on singular values of L streams of the first channel information and a weight coefficient corresponding to each piece of singular value information in the singular values of the L streams. The first communication configuration information includes a first key used for encrypted communication. A value of L is the third quantity of streams. The singular values of the L streams are greater than singular values of Rank1 streams corresponding to the first channel information and except the L streams. Rank1 is the maximum quantity of streams corresponding to the first channel information. Then, the first communication apparatus may send, to the second communication apparatus based on the first key in the first communication configuration information, information encrypted based on the first key.

The first communication apparatus may determine a first parameter

$$ℒ ( {H}_{ba} ) = {\sum }_{l = 1}^{L} {w}_{l} * {σ}_{l} ( {H}_{ba} )$$

based on the singular values of the L streams of the first channel information (H_{ba}) and the weight coefficient corresponding to each piece of singular value information in the singular values of the L streams. The first communication apparatus may generate the first key [symbol] ( [symbol] (H_{ba})) based on quantization information of [symbol] (H_{ba}) in combination with an encryption algorithm (for example, a double-threshold cryptography technology).

In addition, optionally, the first communication apparatus may further determine, based on the first parameter [symbol] (H_{ba}), precoding information, a transmission resource, a channel coding parameter, a modulation parameter, a transmission resource, and/or the like to be used when sending the encrypted information to the second communication apparatus. In other words, the first communication configuration information may further include one or more of the precoding information, the transmission resource, the channel coding parameter, the modulation parameter, and/or the transmission resource.
S1104: The second communication apparatus sends encrypted information to the first communication apparatus based on the second channel information and the third quantity of streams.

First, the second communication apparatus determines second communication configuration information based on singular values of L streams of the second channel information and a weight coefficient corresponding to each piece of singular value information in the singular values of the L streams. The second communication configuration information includes a second key used for encrypted communication. A value of L is the third quantity of streams. The singular values of the L streams are greater than singular values of Rank2 streams corresponding to the second channel information and except the L streams. Rank2 is the maximum quantity of streams corresponding to the second channel information. Then, the second communication apparatus may send, to the first communication apparatus, information encrypted based on the second key.

The second communication apparatus may determine a second parameter

$$ℒ ( {H}_{ab} ) = {\sum }_{l = 1}^{L} {w}_{l} * {σ}_{l} ( {H}_{ab} )$$

based on the singular values of the L streams of the second channel information (H_{ab}) and the weight coefficient corresponding to each piece of singular value information in the singular values of the L streams. The second communication apparatus may generate the second key [symbol] ( [symbol] (H_{ab})) based on quantization information of [symbol] (H_{ba}) in combination with an encryption algorithm (for example, the double-threshold cryptography technology).

As described in the foregoing embodiments, the first parameter [symbol] (H_{ba}) and the second parameter [symbol] (H_{ab}) satisfy the following relation:

$$\vert ℒ ( {H}_{ab} ) - ℒ ( {H}_{ba} ) \vert \leq {\sum }_{l = 1}^{L} {w}_{l} * {σ}_{1} ( E ) = UB .$$

In other words, there is a small difference between [symbol] (H_{ab}) and [symbol] (H_{ba}). Based on this feature, the quantization information of [symbol] (H_{ab}) and the quantization information of (H_{ba}) may be considered as same information. Therefore, the second key [symbol] ( [symbol] (H_{ab})) generated based on the quantization information of [symbol] (H_{ab}) is the same as the first key [symbol] ( [symbol] (H_{ba})) generated based on the quantization information of [symbol] (H_{ba}).

In addition, optionally, the second communication apparatus may further determine, based on the second parameter [symbol] (H_{ab}), precoding information, a channel coding parameter, a modulation parameter, a transmission resource, and/or the like to be used when sending the encrypted information to the first communication apparatus.

In the foregoing method shown in FIG. 11, both authorized communication parties use the same quantity L of streams to preprocess the channel information, so that consistency of information extracted by both communication parties can be improved. Communication keys are generated based on the consistent information, so that encryption consistency of both authorized communication parties can be improved, to reduce encryption computational complexity and communication overheads.

For ease of implementation, the following uses an example in which the first communication apparatus generates the first key [symbol] ( [symbol] (H_{ba})) based on the quantization information of [symbol] (H_{ba}) in combination with the double-threshold cryptography technology and the second communication apparatus generates the second key [symbol] ( [symbol] (H_{ab})) based on the quantization information of [symbol] (H_{ab}) in combination with the double-threshold cryptography technology for detailed description. It can be learned from the foregoing embodiments that

$$\vert ℒ ( {H}_{ab} ) - ℒ ( {H}_{ba} ) \vert \leq {\sum }_{l = 1}^{L} {w}_{l} * {σ}_{1} ( E ) = UB .$$

In embodiments of this disclosure, thresholds involved in the double-threshold cryptography technology may be determined based on UB.

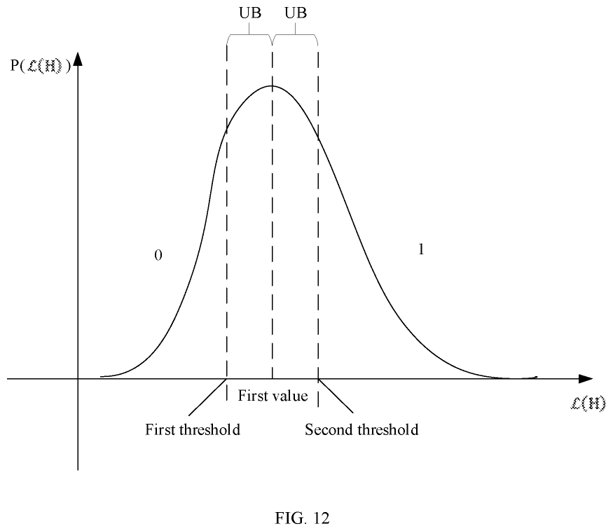

For example, FIG. 12 is a diagram of a probability distribution corresponding to key generation. Probability distribution information corresponding to [symbol] (H) is denoted as P( [symbol] (H)), which satisfies a normal distribution, for example, a Gaussian distribution or a multi-peak normal distribution. A first threshold and a second threshold both differ from a first value of [symbol] (H) by UB. The first threshold is less than the second threshold. The first value of [symbol] (H) is a central point. P( [symbol] (H)) corresponding to the first value is the largest. Quantization information of a value of [symbol] (H) less than the first threshold may be set to 0. Quantization information of a value of [symbol] (H) greater than the second threshold may be set to 1. Based on this, if [symbol] (H_{ba}) and [symbol] (H_{ab}) are values of [symbol] (H) less than the first threshold, the quantization information of [symbol] (H_{ba}) and the quantization information of [symbol] (H_{ab}) are the same and are both 0, and the first key [symbol] ( [symbol] (H_{ba})) and the second key [symbol] ( [symbol] (H_{ab})) generated based on the same quantization information are also the same. If [symbol] (H_{ba}) and [symbol] (H_{ab}) are values of [symbol] (H) greater than the second threshold, the quantization information of [symbol] (H_{ba}) and the quantization information of [symbol] (H_{ab}) are the same and are both 1, and the first key [symbol] ( [symbol] (H_{ba})) and the second key [symbol] ( [symbol] (H_{ab})) generated based on the same quantization information are also the same.

In this design, physical channel information in a continuous real number domain can be mapped to a discrete integer domain, and combination with a physical-layer key solution (for example, the double-threshold cryptography technology) improves an agreement rate of physical-layer keys of both communication parties and prevents an unauthorized user from obtaining the keys. In addition, a key generation solution provided in embodiments of this disclosure is applied to physical-layer encryption, and information reconciliation does not need to be performed. This can reduce computational complexity and overheads of interaction between the network device and the terminal device on an air interface.

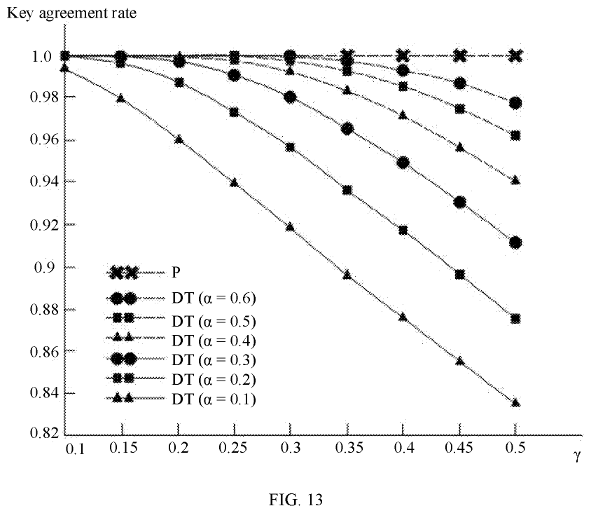

Compared with another double-threshold encryption solution, an encryption solution designed by combining the double-threshold cryptography technology with consistency of extracted channel information in embodiments of this disclosure achieves a higher agreement rate of keys used by both communication parties. For example, in FIG. 13 to FIG. 15, DT represents the other double-threshold encryption solution. In DT, thresholds are selected as H̅±α·s(H). H̅ is a mean of sampled data. s(H) is a standard deviation of the sampled data. Proposed (P for short in the figures) represents the encryption solution provided in embodiments of this disclosure. In FIG. 13 to FIG. 15, a horizontal coordinate y is a variance of a Gaussian distribution obeyed by an element of a noise matrix involved in the encryption solution. A value of y is related to inconsistent observed values of uplink and downlink channels due to receiver noise, imperfect channel reciprocity, or other interference in both communication parties. In FIG. 13 to FIG. 15, a vertical coordinate represents a key agreement rate.

FIG. 13 shows curves of key agreement rates corresponding to various values of a in DT and a key agreement rate corresponding to this disclosure. FIG. 13 shows that a key agreement rate of both authorized communication parties (for example, the first communication apparatus and the second communication apparatus) in Proposed remains 100% as γ increases. For DT, FIG. 13 shows change curves of the key agreement rates corresponding to the various values of α. It can be found that the key agreement rate corresponding to each value of α gradually decreases as γ increases. This indicates that when there is a large difference between observed values of channels between both authorized communication parties, DT cannot ensure that keys generated by both authorized communication parties are completely consistent. Even though increasing the parameter a improves the corresponding key agreement rate, a key agreement rate of 100% still cannot be ensured when y is large.

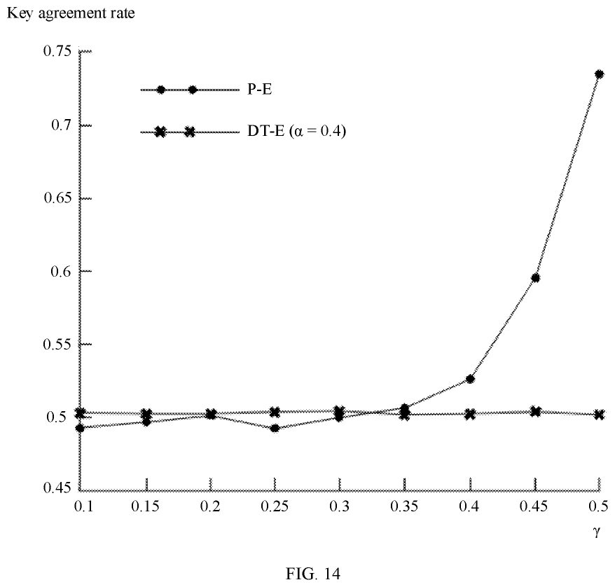

In FIG. 14, P-E is a change curve of an agreement rate of a key generated by an unauthorized user based on the third quantity of streams and channel information estimated by the unauthorized user and a key generated by both authorized communication parties through Proposed, and DT-E is a change curve of an agreement rate of a key generated by the unauthorized user through DT and a key generated by both authorized communication parties through DT when α is set to 0.4. Based on FIG. 14, it can be found that for most values of γ, the agreement rate of P-E is lower than that of DT-E. This indicates that compared with the other double-threshold encryption solution, the encryption solution provided in this disclosure further reduces a probability of password leakage of both authorized communication parties and improves key confidentiality, to improve an information security coefficient of both authorized communication parties.

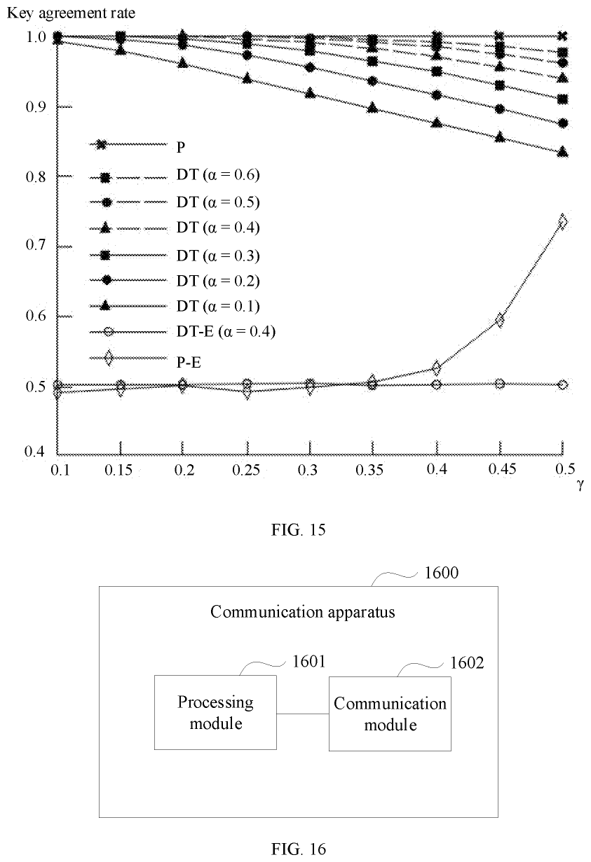

Based on FIG. 13 and FIG. 14, FIG. 15 shows that the key agreement rate of the curve P-E is lower than that of the curve P, and the key agreement rate of the curve DT-E is lower than that of the curve DT when a is set to 0.4. This indicates that the key generated by the unauthorized user is inconsistent with the key of both authorized communication parties, and the unauthorized user cannot obtain encrypted information of both authorized communication parties, so that information security of both authorized communication parties can be ensured.

Based on a same concept, refer to FIG. 16. An embodiment of this disclosure provides a communication apparatus 1600. The communication apparatus 1600 includes a processing module 1601 and a communication module 1602. The communication apparatus may be the foregoing first communication apparatus or second communication apparatus.

The communication module may also be referred to as a transceiver module, a transceiver, a transceiver device, a transceiver apparatus, or the like. The processing module may also be referred to as a processor, a processing board, a processing unit, a processing apparatus, or the like. Optionally, the communication module is configured to perform a sending operation and a receiving operation on the terminal device side or the access network device side in the foregoing method. A component configured to implement a receiving function in the communication module may be considered as a receiving unit, and a component configured to implement a sending function in the communication module may be considered as a sending unit. In other words, the communication module includes the receiving unit and the sending unit.

When the communication apparatus 1600 is the first communication apparatus, the processing module 1601 may be configured to implement processing functions of the first communication apparatus in the embodiments shown in FIG. 5 to FIG. 11, and the communication module 1602 may be configured to implement receiving and sending functions of the first communication apparatus in the embodiments shown in FIG. 5 to FIG. 11.

When the communication apparatus 1600 is the second communication apparatus, the processing module 1601 may be configured to implement processing functions of the second communication apparatus in the embodiments shown in FIG. 5 to FIG. 11, and the communication module 1602 may be configured to implement receiving and sending functions of the second communication apparatus in the embodiments shown in FIG. 5 to FIG. 11.

In addition, it should be noted that the communication module and/or the processing module may be implemented by using a virtual module. For example, the processing module may be implemented by using a software functional unit or a virtual apparatus, and the communication module may be implemented by using a software function or a virtual apparatus. Alternatively, the processing module or the communication module may be implemented by a physical apparatus. For example, if the communication apparatus is implemented by a chip/chip circuit, the communication module may be an input/output circuit and/or a communication interface, and performs an input operation (corresponding to the foregoing receiving operation) and an output operation (corresponding to the foregoing sending operation). The processing module is an integrated processor, a microprocessor, or an integrated circuit.

Division into the modules in this embodiment of this disclosure is an example, is merely logical function division, and may be other division during actual implementation. In addition, functional modules in each of embodiments of this disclosure may be integrated into one processor, each of the modules may exist alone physically, or two or more modules may be integrated into one module. The integrated module may be implemented in a form of hardware, or may be implemented in a form of a software functional module.

Based on a same technical concept, an embodiment of this disclosure further provides a communication apparatus 1700. For example, the communication apparatus 1700 may be a chip or a chip system. Optionally, in embodiments of this disclosure, the chip system may include a chip, or may include a chip and another discrete component.

The communication apparatus 1700 may be configured to implement a function of any network element in the communication system described in the foregoing embodiments. The communication apparatus 1700 may include at least one processor 1710. The processor 1710 is coupled to a memory. Optionally, the memory may be located inside the communication apparatus; the memory may be integrated with the processor; or the memory may be located outside the communication apparatus. For example, the communication apparatus 1700 may further include at least one memory 1720. The memory 1720 stores a necessary computer program, a computer program, or instructions and/or data for implementing any one of the foregoing embodiments. The processor 1710 may execute the computer program stored in the memory 1720, to complete the method in any one of the foregoing embodiments.

The communication apparatus 1700 may further include a communication interface 1730. The communication apparatus 1700 may perform information interaction with another device through the communication interface 1730. For example, the communication interface 1730 may be a transceiver, a circuit, a bus, a module, a pin, or a communication interface of another type. When the communication apparatus 1700 is a chip-type apparatus or circuit, the communication interface 1730 in the communication apparatus 1700 may alternatively be an input/output circuit, and may input information (or receive information) and output information (or send information). The processor is an integrated processor, a microprocessor, an integrated circuit, or a logic circuit. The processor may determine output information based on input information.

The coupling in embodiments of this disclosure may be an indirect coupling or a communication connection between apparatuses, units, or modules in an electrical form, a mechanical form, or another form, and is used for information exchange between the apparatuses, the units, or the modules. The processor 1710 may operate in collaboration with the memory 1720 and the communication interface 1730. A specific connection medium between the processor 1710, the memory 1720, and the communication interface 1730 is not limited in embodiments of this disclosure.

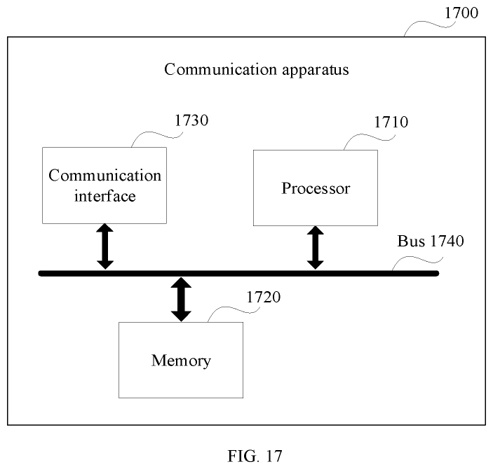

Optionally, with reference to FIG. 17, the processor 1710, the memory 1720, and the communication interface 1730 are connected to each other through a bus 1740. The bus 1740 may be a Peripheral Component Interconnect (PCI) bus, an Extended Industry Standard Architecture (EISA) bus, or the like. The bus may be classified as an address bus, a data bus, a control bus, or the like. For ease of representation, only one bold line is used for representation in FIG. 17, but this does not mean that there is only one bus or only one type of bus.

In embodiments of this disclosure, the processor may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this disclosure. The general-purpose processor may be a microprocessor, any other processor, or the like. The steps of the method disclosed with reference to embodiments of this disclosure may be directly performed by a hardware processor, or may be performed by using a combination of hardware in the processor and a software module.

In embodiments of this disclosure, the memory may be a non-volatile memory, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in embodiments of this disclosure may alternatively be a circuit or any other apparatus that can implement a storage function, and is configured to store the program instructions and/or the data.

In a possible implementation, the communication apparatus 1700 may be used in a first communication apparatus. The communication apparatus 1700 may be the first communication apparatus, or may be an apparatus that can support the first communication apparatus to implement a function of the first communication apparatus in any one of the foregoing embodiments. The memory 1720 stores a computer program (or instructions) and/or data for implementing the function of the first communication apparatus in any one of the foregoing examples. The processor 1710 may execute the computer program stored in the memory 1720, to implement the method performed by the first communication apparatus in any one of the foregoing embodiments. When the communication apparatus 1700 is used in the first communication apparatus, the communication interface in the communication apparatus 1700 may be configured to interact with a second communication apparatus, and send information to the second communication apparatus or receive information from the second communication apparatus.

In a possible implementation, the communication apparatus 1700 may be used in a second communication apparatus. The communication apparatus 1700 may be the second communication apparatus, or may be an apparatus that can support the second communication apparatus to implement a function of the second communication apparatus in any one of the foregoing embodiments. The memory 1720 stores a computer program (or instructions) and/or data for implementing the function of the second communication apparatus in any one of the foregoing embodiments. The processor 1710 may execute the computer program stored in the memory 1720, to implement the method performed by the second communication apparatus in any one of the foregoing embodiments. When the communication apparatus 1700 is used in the second communication apparatus, the communication interface in the communication apparatus 1700 may be configured to interact with a first communication apparatus, and send information to the first communication apparatus or receive information from the first communication apparatus.

The communication apparatus 1700 provided in this embodiment may be used in the first communication apparatus to complete the method performed by the first communication apparatus, or may be used in the second communication apparatus to complete the method performed by the second communication apparatus. Therefore, for technical effects that can be achieved by the communication apparatus 1700, refer to the foregoing method examples. Details are not described herein again.

Based on the foregoing embodiments, an embodiment of this disclosure provides a communication system, including a first communication apparatus and a second communication apparatus. The first communication apparatus and the second communication apparatus may implement the methods provided in the embodiments shown in FIG. 5 to FIG. 11.

The technical solutions provided in this embodiment of this disclosure may be fully or partially implemented through software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, the procedure or functions according to embodiments of this disclosure are all or partially generated. The computer may be a general-purpose computer, a dedicated computer, a computer network, a terminal device, an access network device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device like a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

In embodiments of this disclosure, on the premise of no logical contradiction, embodiments may be mutually referenced. For example, methods and/or terms may be mutually referenced between method embodiments. For example, functions and/or terms may be mutually referenced between apparatus embodiments. For example, functions and/or terms may be mutually referenced between an apparatus embodiment and a method embodiment.

A person skilled in the art may make various modifications and variations to embodiments of this disclosure without departing from the scope of embodiments of this disclosure. In this way, embodiments of this disclosure are also intended to cover these modifications and variations provided that they fall within the scope of the claims of embodiments of this disclosure and equivalent technologies thereof.

1. A method applied to a first communication apparatus and comprising:
obtaining, based on a first quantity of streams or a second quantity of streams, a third quantity of streams, wherein the first quantity is based on first channel information from a second communication apparatus to the first communication apparatus, wherein the second quantity is based on second channel information from the first communication apparatus to the second communication apparatus, and wherein the third quantity is less than or equal to a maximum quantity of streams corresponding to the first channel information; and
sending, to the second communication apparatus and based on the first channel information and the third quantity, information.

2. The method of claim 1, wherein the first quantity of streams satisfies a first condition, and wherein the first condition is based on a signal-to-noise ratio corresponding to the first channel information and a first singular value of at least one stream of the first channel information.

3. The method of claim 2, wherein the first condition comprises: a ratio of a second singular value of a primary stream of the first channel information to a third singular value of an i^{th} stream in fourth singular values of L1 streams of the first channel information is less than or equal to a first threshold, wherein the first threshold is based on the signal-to-noise ratio corresponding to the first channel information, wherein i is an integer from 1 to L1, and wherein a value of the first quantity of streams is L1.

4. The method of claim 1, further comprising:
determining, based on singular values of L streams of the first channel information and weight coefficients corresponding to the singular values, first communication configuration information, wherein L is the third quantity, and wherein the first communication configuration information comprises one or more of precoding information, a channel coding parameter, a modulation parameter, or a first key used for encrypted communication; and
further sending, based on the first communication configuration information, the information.

5. The method of claim 4, further comprising:
determining, based on the singular values and the weight coefficients, a first parameter; and
further determining, based on the first parameter, the first communication configuration information.

6. The method of claim 5, wherein the first parameter satisfies the following equation:
$$ℒ ( {H}_{ba} ) = {\sum }_{l = 1}^{L} {w}_{l} * {σ}_{l} ( {H}_{ba} ) ,$$
wherein [symbol] (H_{ba}) is the first parameter, wherein wₗ indicates one of the weight coefficients corresponding to an l^{th} piece of singular value information in the singular values, wherein H_{ba} indicates the first channel information, wherein σₗ(H_{ba}) indicates a singular value of an l^{th} stream in the singular values, and wherein l is an integer from 1 to L.

7. The method of claim 1, wherein obtaining the third quantity comprises:
receiving, from the second communication apparatus, a first indication of the third quantity, wherein the third quantity is less than or equal to the second quantity;
sending, to the second communication apparatus, the first quantity, and receiving, from the second communication apparatus, first indication information, wherein either:
the first indication information indicates that the first quantity is the same as the second quantity, and the third quantity is the first quantity; or
the first indication information indicates the third quantity, and the third quantity is less than or equal to the smaller one of the first quantity and the second quantity; or
receiving, from the second communication apparatus, a second indication of the second quantity, and determining, based on the first quantity and the second quantity, the third quantity, wherein:
the third quantity is the first quantity when the first quantity is the same as the second quantity; and
the third quantity is less than or equal to the smaller one of the first quantity and the second quantity when the first quantity is different from the second quantity.

8. A method applied to a second communication apparatus and comprising:
obtaining, based on a first quantity of streams or a second quantity of streams, a third quantity of streams, wherein the first quantity is based on first channel information from the second communication apparatus to a first communication apparatus, wherein the second quantity is based on second channel information from the first communication apparatus to the second communication apparatus, and wherein the third quantity is less than or equal to a maximum quantity of streams corresponding to the second channel information; and
sending, to the first communication apparatus and based on the second channel information and the third quantity, information.

9. The method of claim 8, wherein the second quantity of streams satisfies a second condition, and wherein the second condition is based on a signal-to-noise ratio corresponding to the second channel information and a first singular value of at least one stream of the second channel information.

10. The method of claim 9, wherein the second condition comprises: a ratio of a second singular value of α primary stream of the second channel information to a third singular value of a j^{th} stream in fourth singular values of L2 streams of the second channel information is less than or equal to a second threshold, wherein the second threshold is based on the signal-to-noise ratio corresponding to the second channel information, wherein j is an integer from 1 to L2, and wherein a value of the second quantity of streams is L2.

11. The method of claim 8, further comprising:
determining, based on singular values of L streams of the second channel information and weight coefficients corresponding to the singular values, second communication configuration information, wherein L is the third quantity, and wherein the second communication configuration information comprises one or more of precoding information, a channel coding parameter, a modulation parameter, or a second key used for encrypted communication; and
further sending, based on the second communication configuration information, the information.

12. The method of claim 11, further comprising:
further determining, based on the second parameter, the second communication configuration information.

13. The method of claim 8, wherein obtaining the third quantity comprises:
receiving, from the first communication apparatus, a first indication of the third quantity, wherein the third quantity is less than or equal to the first quantity;
sending, to the first communication apparatus, the second quantity, and receiving, from the first communication apparatus, second indication information, wherein either:
the second indication information indicates that the first quantity is the same as the second quantity, and the third quantity is the second quantity; or
the second indication information indicates the third quantity, and the third quantity is less than or equal to the smaller one of the first quantity and the second quantity; or
receiving, from the first communication apparatus, a second indication of the first quantity, and determining, based on the first quantity and the second quantity, the third quantity, wherein:
the third quantity is the second quantity when the first quantity is the same as the second quantity; and
the third quantity is less than or equal to the smaller one of the first quantity and the second quantity when the first quantity is different from the second quantity.

14. A first communication apparatus comprising:
a memory configured to store instructions; and
at least one processor coupled to the memory and configured to execute the instructions to cause the first communication apparatus to:
obtain, based on a first quantity of streams or a second quantity of streams, a third quantity of streams, wherein the first quantity is based on first channel information from a second communication apparatus to the first communication apparatus, wherein the second quantity is based on second channel information from the first communication apparatus to the second communication apparatus, and wherein the third quantity is less than or equal to a maximum quantity of streams corresponding to the first channel information; and
send, to the second communication apparatus and based on the first channel information and the third quantity, information.

15. The first communication apparatus of claim 14, wherein the first quantity of streams satisfies a first condition, and wherein the first condition is based on a signal-to-noise ratio corresponding to the first channel information and a first singular value of at least one stream of the first channel information.

16. The first communication apparatus of claim 15, wherein the first condition comprises: a ratio of a second singular value of a primary stream of the first channel information to a third singular value of an i^{th} stream in fourth singular values of L1 streams of the first channel information is less than or equal to a first threshold, wherein the first threshold is based on the signal-to-noise ratio corresponding to the first channel information, wherein i is an integer from 1 to L1, and wherein a value of the first quantity of streams is L1.

17. The first communication apparatus of claim 14, wherein the at least one processor is further configured to execute the instructions to cause the first communication apparatus to:
determine, based on singular values of L streams of the first channel information and weight coefficients corresponding to the singular values, first communication configuration information, wherein L is the third quantity, and wherein the first communication configuration information comprises one or more of precoding information, a channel coding parameter, a modulation parameter, or a first key used for encrypted communication; and
further send, based on the first communication configuration information, the information.

18. The first communication apparatus of claim 17, wherein the at least one processor is further configured to execute the instructions to cause the first communication apparatus to:
determine, based on the singular values and the weight coefficients, a first parameter; and
further determine, based on the first parameter, the first communication configuration information.

19. The first communication apparatus of claim 18, wherein the first parameter satisfies the following equation:
$$ℒ ( {H}_{ba} ) = {\sum }_{l = 1}^{L} {w}_{l} * {σ}_{l} ( {H}_{ba} ) ,$$
wherein [symbol] (H_{ba}) is the first parameter, wherein wₗ indicates one of the weight coefficients corresponding to an l^{th} piece of singular value information in the singular values, wherein H_{ba} indicates the first channel information, wherein σₗ(H_{ba}) indicates a singular value of an l^{th} stream in the singular values, and wherein l is an integer from 1 to L.

20. The first communication apparatus of claim 14, wherein the at least one processor is further configured to execute the instructions to cause the first communication apparatus to obtain the third quantity by:
receiving, from the second communication apparatus, a first indication of the third quantity, wherein the third quantity is less than or equal to the second quantity;
sending, to the second communication apparatus, the first quantity, and receiving, from the second communication apparatus, first indication information, wherein either:
the first indication information indicates that the first quantity is the same as the second quantity, and the third quantity is the first quantity; or
the first indication information indicates the third quantity, and the third quantity is less than or equal to the smaller one of the first quantity and the second quantity; or
receiving, from the second communication apparatus, a second indication of the second quantity, and determining, based on the first quantity and the second quantity, the third quantity, wherein:
the third quantity is the first quantity when the first quantity is the same as the second quantity; and
the third quantity is less than or equal to the smaller one of the first quantity and the second quantity when the first quantity is different from the second quantity.
